(19) United States
(12) Patent Application Publication
(10) Pub. No.: US 2015/0081362 A1
(43) Pub. Date: Mar. 19, 2015

(54) CONTEXT-AWARE DISTRIBUTIVE TAXI CAB DISPATCHING

(71) Applicants: Stephen C. Chadwick, Chandler, AZ (US); Charles Baron, Chandler, AZ (US)

(72) Inventors: Stephen C. Chadwick, Chandler, AZ (US); Charles Baron, Chandler, AZ (US)

(21) Appl. No.: 14/125,549

(22) PCT Filed: Sep. 13, 2013
(86) PCT No.: PCT/US2013/059733

§ 371 Date: Dec. 11, 2013

(51) Int. Cl. G06Q 50/30; G06Q 10/06

(52) U.S. Cl. CPC G06Q 50/30; G06Q 10/06311
USPC 705/7.14

(57) ABSTRACT

Technologies are presented that provide a cloud-based context-aware distributive taxi cab dispatching service to registered users. A method of providing this service may include receiving, from a user device of a registered user, a request for taxi information, obtaining the requested information from one or more computing devices of one or more taxi cabs or taxi service companies and one or more data stores, and providing the obtained information to the user device. The provided taxi information may be based on a passenger profile of the user and may include a list of taxi cabs recommended based on the profile. The method may further include scheduling a selected taxi cab. The method may also include monitoring the user's location and updating the scheduling of the taxi based on the user's location. The method may also include monitoring the user's location while in a taxi for data collection and safety reasons.

### BACKGROUND

Arranging for transportation can often be challenging, especially when a traveler is in an unfamiliar city and/or foreign country. Often, a traveler will leverage the first local taxi service that is available. However, there may be various types of risks involved with this approach. For example, when calling a service for, or hailing, a taxi, there may be a language barrier involved, which may make describing the location for pick-up and/or the desired destination difficult for a passenger to communicate. Furthermore, finding the passenger for a pick up may be a challenge for the driver (e.g., if the urban density is great). As another example, once a passenger is picked up, the passenger may take on a financial risk, due not only to a potential language barrier, but also due to not being familiar with the local region. For instance, a passenger may be set up for a financial loss if a taxi driver is dishonest and/or takes an unnecessarily longer route to the passenger's desired destination. In yet another example, a passenger may be made to feel uncomfortable in a taxi that reeks of cigarette smoke or has an extremely filthy interior. Under extreme circumstances, a personal safety risk may also be involved (e.g., in unsafe neighborhoods, in portions of the world that may be unstable, etc.), where an unsuspecting passenger may be unexpectedly taken to or driven through a dangerous area, or worse, kidnapped and/or held for ransom. In short, finding transportation that is efficient, comfortable, cost-effective, and safe may be a difficult undertaking.

### BRIEF DESCRIPTION OF THE DRAWINGS/FIGURES

FIG. 1 is a block diagram of an example system described herein, according to an embodiment.

FIGS. 2-9 illustrate sequence diagrams of example process flows described herein, according to various embodiments.

FIGS. 10-19 are flow charts illustrating example process flows, as described herein, from the perspective of a distributive taxi dispatching server, according to various embodiments.

FIGS. 20-27 are flow charts illustrating example process flows, as described herein, from the perspective of a user device, according to various embodiments,

FIG. 28 is a block diagram of an example distributive taxi dispatching server, according to an embodiment.

FIG. 29 is a block diagram of an example taxi service server or taxi cab device, according to an embodiment.

FIG. 30 is a block diagram of an example user device, according to an embodiment. In the drawings, the leftmost digit(s) of a reference number may identify the drawing in which the reference number first appears.

### DETAILED DESCRIPTION

Disclosed herein are technologies that solve the technical problem of how to provide taxi service to a traveler that facilitates a convenient, comfortable, efficient, cost-effective, and safe, taxi ride experience. With the technologies disclosed herein, the described third-party cloud-based taxi service may allow a user of the service to use a personal computing device to request and use taxi service by leveraging one or more of the traveler's location and preferences, along with one or more of the location, pricing, availability, and historical review data of one or more taxi service companies and/or cabs. By using this service, a real-time match between the traveler and a cab may be coordinated to provide the traveler with a comfortable, cost-effective, and safe ride to the traveler's desired destination.

Embodiments are now described with reference to the figures, where like reference numbers may indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

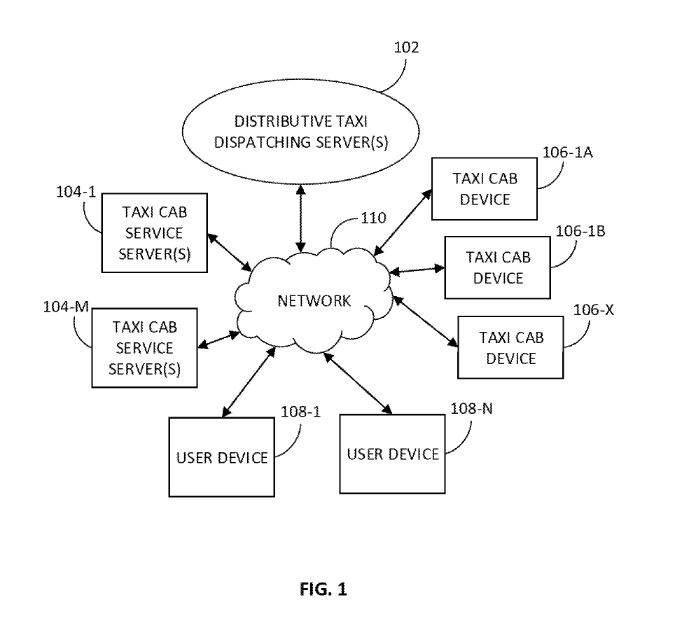

FIG. 1 is a block diagram of an example system 100, according to an embodiment. System 100 may include a distributive taxi dispatching server 102, of a distributive taxi dispatching service. System 100 may also include one or more taxi cab service servers 104-1 to 104-M (collectively, 104) of one or more subscribing taxi cab services and/or one or more taxi cab devices 106-1 to 106-X that are located within subscribing taxi cabs. One or more of the taxi cabs that contain the taxi cab devices 106 may or may not be taxi cabs of one of the subscribing taxi cab services. For example, taxi cab devices 106-1.A and 106-1B may be within taxi cabs associated with a subscribing taxi service that maintains taxi cab service server 104-1, for example, while taxi cab device 106-X may be within a subscribing privately owned taxi cab. The subscribing taxi cab services and taxi cabs are registered with the distributive taxi dispatching service. System 100 may also include one or more user devices 108-1 to 108-N (collectively, 108) of users of the distributive taxi dispatching service (e.g., taxi passengers). The distributive taxi dispatching server 102, the taxi cab service servers 104, the taxi cab devices 106, and the user devices 108 may be in communication via a network 110.

The distributive taxi dispatching server 102 may be implemented in software and/or hardware executed or controlled by a controller of the distributive taxi dispatching server 102. While only one distributive taxi dispatching server is illustrated for clarity and ease of discussion, it should be appreciated that the distributive taxi dispatching server may include multiple distributed server computers for redundancy and/or load sharing, for example.

The taxi cab service servers 104 may each be implemented in software and/or hardware executed or controlled by a controller of each taxi cab service server 104. While only one taxi cab service server 104 per taxi cab service is illustrated for clarity and ease of discussion, it should be appreciated that each taxi cab service server may include multiple distributed server computers for redundancy and/or load sharing, for example. In embodiments, taxi cab service servers 104 may be owned and/or maintained by taxi cab service companies. In other embodiments, taxi cab service servers 104 may be provided by, and maintained by, administrators of the distributive taxi dispatching service.

The taxi cab devices 106 may be computing devices that may include mobile devices (e.g., that may be removed from the cab) and non-mobile devices (e.g., that may not be readily removable from the cab). Mobile devices may include, but are not to be limited to, for example, laptop computers, ultra-laptop computers, tablets, touch pads, portable computers, handheld computers, palmtop computers, personal digital assistants (PDAs), e-readers, cellular telephones, combination cellular telephone/PDAs, mobile smart devices (e.g., smart phones, smart tablets, etc.), mobile internet devices (MIDs), mobile messaging devices, mobile data communication devices, mobile media playing devices, cameras, etc. Non-mobile devices may include, but are not to be limited to, for example, personal computers (PCs), custom computers, data communication devices, media playing devices, etc. The taxi cab devices 106 are devices that may include controllers and other components that execute software and/or control hardware in order to execute local programs or provide services and/or data to external service providers over a network. For example, the taxi cab devices 106 may include one or more software clients or applications for utilizing or accessing web-based services (e.g., travel-related services, dispatching-related services, etc.). The taxi cab devices 106 may also, or instead, include a web interface running in a browser from which a taxi cab device may access such web-based. services. Taxi cab devices 106 may also include storage devices (not shown in FIG. 1) to store logic and data associated With the programs and services that are used and/or accessed. Taxi cab devices 106 may also include location-aware capabilities or devices, such as global positioning system (GPS) devices or devices with similar capabilities. In embodiments, taxi cab devices 106 may he owned and/or maintained by taxi cab service companies or taxi cab drivers. In other embodiments, taxi cab devices 106 may be provided by, and maintained by, administrators of the distributive taxi dispatching service.

The user devices 108 may be computing devices hat may include mobile and non-mobile devices. Mobile devices may include, but are not to be limited to, for example, laptop computers, ultra-laptop computers, tablets, touch pads, portable computers, handheld computers, palmtop computers, personal digital assistants (PDAs), c-readers, cellular telephones, combination cellular telephone/PDAs, mobile smart devices (e.g., smart phones, smart tablets, etc.), mobile internet devices (MIDs), mobile messaging devices, mobile data communication devices, mobile media playing devices, cameras, mobile gaming consoles, etc. Non-mobile devices may include, but are not to be limited to, for example, personal computers (PCs), televisions, smart televisions, data communication devices, media playing devices, gaming consoles, etc. The user devices 108 are user devices (e.g., personal user devices of passengers) that may include controllers and other components that execute software and/or control hardware in order to execute local programs or consume services provided by external service providers over a network. For example, the user devices 108 may include one or more software clients or applications for utilizing or accessing web-based services (e.g., online travel-related services, etc.). The user devices 108 may also, or instead, include a web interface running in a browser from which the user device can access such web-based services. User devices 108 may also include storage devices (not shown in FIG. 1) to store logic and data associated with the programs and services used by the users of the user devices. User devices 108 may also include location-aware capabilities or devices, such as global positioning system (GPS) devices or devices with similar capabilities.

The network 110 may be any wired or wireless network, such as a Wide Area Network (WAN), a Local Area Network (LAN), and/or the like. As an example, the network 110 may be a distributed public network, such as the Internet, where the distributive taxi dispatching server 102, the taxi cab service servers 104, the taxi cab devices 106, and the user devices 108 are connected to the network 110 via wired or wireless connections.

In embodiments described more fully below, there are various example scenarios involving requesting taxi service that may assist in the discussion. One example scenario may include when a taxi is nearby a user and the user may consider hailing and/or taking it. Another example scenario may include when a user is in need of a taxi, but none are nearby. In this scenario, the user may use the service to request a taxi to be sent to the user's current location or a specified location. In yet another example, a user may desire to request a taxi to pick the user up at some time in the future. In this scenario, the user may not want to be picked up until one or more hours later, or even one or more days later. In this example, the user may be requesting a taxi prior to the user's later arrival at the desired pick-up location, or may even be requesting taxi service prior to a planned future trip on which taxi service may be needed for departure or after arrival at the user's destination. These example scenarios will be discussed herein to simplify understanding of what is disclosed and are not meant to be limiting. Many other example scenarios may be contemplated. In addition, in the embodiments described below, it is assumed that a user of the distributive taxi dispatching service has previously registered for the service and that taxi service companies and/or individual taxi cabs have previously registered with the service. It is also assumed that the user has access to the service via a user device associated with the user e.g., that the user has downloaded a user application associated with the service to a user device, that the user has access to a web page associated with the service on a user device, etc.).

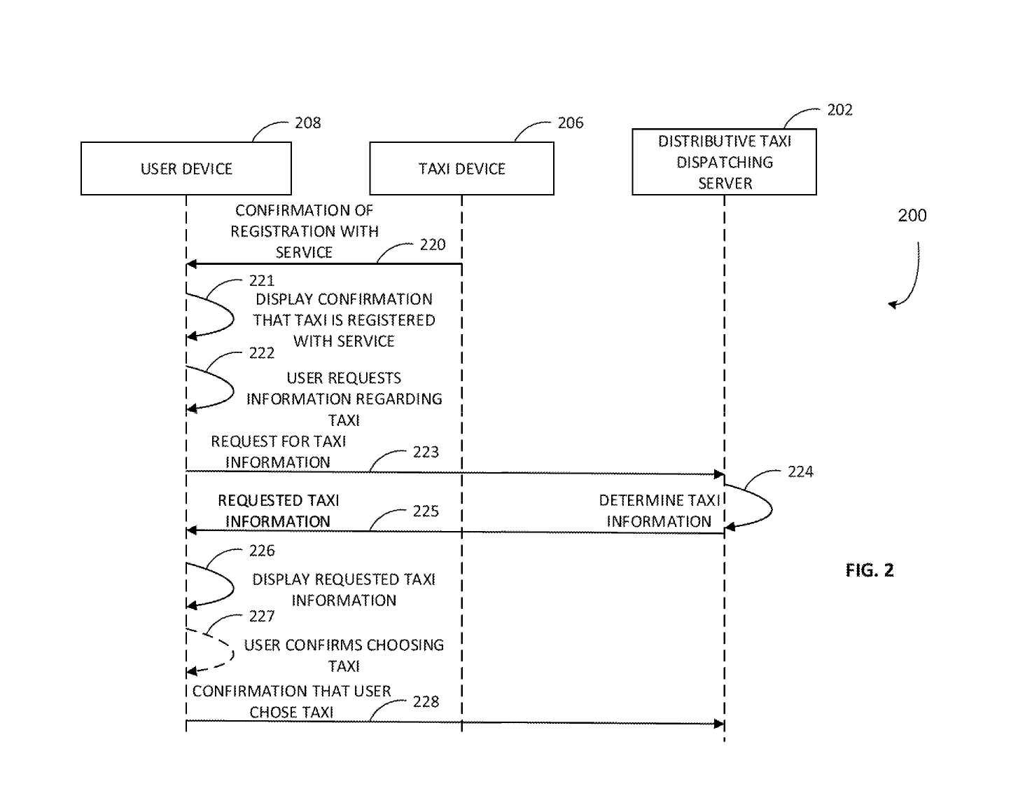

FIG. 2 illustrates a sequence diagram of an example process flow 200 of a distributive taxi dispatching service, according to an embodiment. The embodiment shown in FIG. 2 may be suitable for the scenario described above where a user (and also a user device 208 associated with the user) may be in proximity of one or more taxi cabs on the street (e.g., may be near them, or the user may see them approaching, etc.). In an embodiment, the user device 208 may receive one or more signals (e.g., a near-field Wi-Fi signal, or other near-field signal) from one or more devices 206 within some or all of the one or more taxi cabs (e.g., from a computing device or an embedded tag within the taxi cabs) indicating that the taxi cabs are registered with the distributive taxi cab dispatching service (220), and confirmation that these taxi cabs are registered with the service may be displayed to the user (221). This displayed confirmation may include an identifier of each registered taxi cab, for example, to make it easier for the user to distinguish between multiple registered taxi cabs. In an embodiment, the user may have requested this confirmation information using a user interface on user device 208. In another embodiment, this information may have been “pushed” to the device, without the user requesting it, to let the user know that registered cabs were available nearby in case the user needed one. In an embodiment, the confirmation information may include information regarding the one or more registered taxi cabs. In another embodiment, from the displayed confirmation information, the user may request information regarding the one or mote registered taxi cabs using the user interface of user device 208 (222). A request for information regarding the one or more registered taxi cabs may be sent from the user device 208 to a distributive taxi dispatching server 202. Distributive taxi dispatching server 202 may collect and/or determine information regarding the one or more registered taxi cabs (224). In an embodiment, the distributive taxi dispatching server 202 may collect and/or determine information that includes, but is not to he limited to, for example, availability information, fare information, ratings, etc. In an embodiment, availability information may be retrieved from, for example, servers or computing devices associated with registered taxi service companies associated with the taxi cabs or the registered taxi cabs themselves. Fare information may also be provided in this manner, or may be estimated based on historical data maintained by distributive taxi dispatching server 202. A rating of a taxi cab may be determined by distributive taxi dispatching server 202 using previous input from registered users, automatically collected data from monitored rides of registered users, etc. In an embodiment, a determined rating may further be based on known user preferences that may be maintained, for example, in a passenger profile of the user. The passenger profile of the user may he maintained by distributive taxi dispatching server 202, user device 208, or both. A rating may be determined using one or more algorithms. As there are countless algorithms that may be used for this purpose, as would be understood by those of skill in the art, specific algorithms will not be discussed here. The information regarding the registered taxi cabs collected and/or determined by distributive taxi dispatching server 202 may be provided to user device 208 (225) and displayed (226). In an embodiment, if, based on the provided information, the user decides to take one of the taxis, the user may optionally proactively confirm the user's choice of taxi using the user interface of user device 208 (227). In an embodiment, distributive taxi dispatching server 202 may automatically detect, using geo-location methods (e.g.,. monitoring GPS coordinates of user device 208, triangulation, nearby Wi-Fi access points, or other means), for example, whether the user chose to take one of the taxis. In either embodiment, confirmation of whether the user chose one of the registered taxis may be provided from user device 208 to distributive taxi dispatching server 202 (228).

In an alternate embodiment, rather than directly receiving a confirmation of registration with the service from a device within a taxi cab (as shown by 220-221), a user may request information regarding a specific taxi cab in a different manner. For example, the user may take, via user device 208, a photograph or scan of an identifying feature located on the taxi cab (e.g., a bar code or other type of code identifying the taxi cab, a license plate, a logo, etc.) and may provide it to distributive taxi dispatching server 202 (222/223). Distributive taxi dispatching server 202 may determine, from the identifying feature, the identity of the taxi cab, and other information regarding the taxi cab (as discussed above) (224), and may provide the determined information regarding the taxi cab to the user device (225). Distributive taxi dispatching server 202 may determine the identity of the taxi cab from the identifying feature in any of a variety of ways, including, but not limited to, for example, bar code reading, optical character recognition (OCR), etc. In an embodiment, the user device 208 may fully or partially decipher the identifying feature prior to providing the identifying feature to distributive taxi dispatching server 202 (e.g., may determine an identification code or number represented by a photo or scan, for example, and provide the determined identification code or number to distributive taxi dispatching server 202). A registered taxi cab may visually display a logo or some other indication that it is registered with the distributive taxi dispatching service to make it easier for a user to identify.

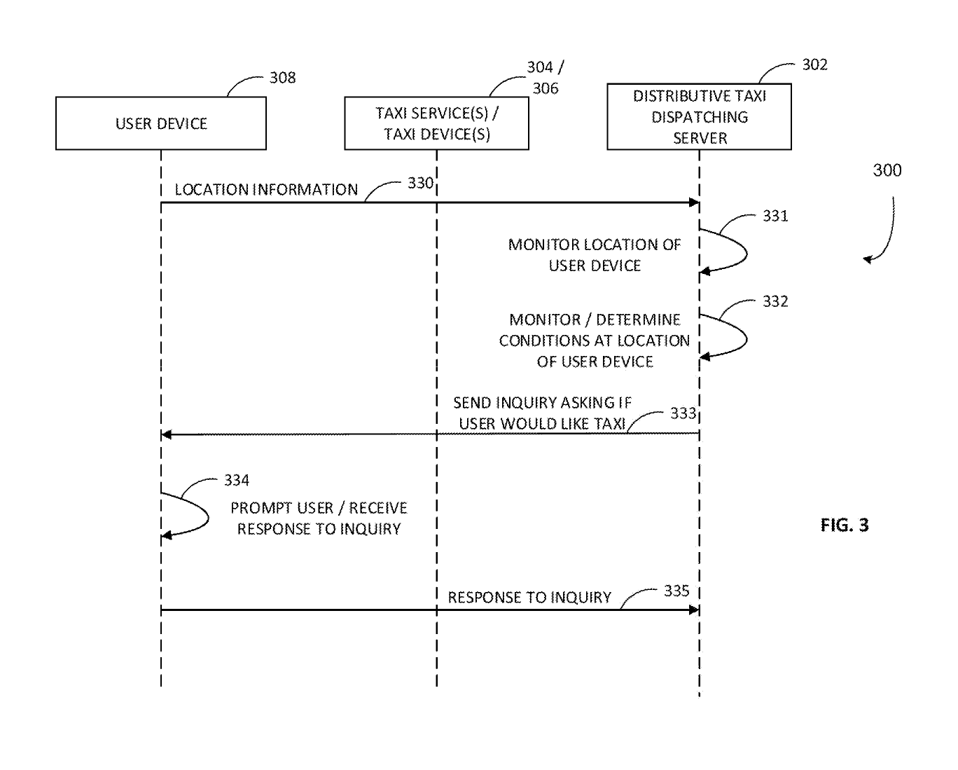

FIG. 3 illustrates a sequence diagram of an example process flow 300 of an automated ride inquiry of a distributive taxi dispatching service, according to an embodiment. In the embodiment shown in FIG. 3, distributive taxi dispatching server 302 may determine, based on the location of the user and conditions at that location, that the user may desire a taxi. For example, the distributive taxi dispatching server 302 may detect, by monitoring the location of user device 308, that the user is walking on a city street, and may also determine that the current conditions at that location include rain, indicating that the user may desire a ride. As shown in FIG. 3, location information may be provided from user device 308 to distributive taxi dispatching server 302 (330). In embodiments, this location information may be requested by distributive taxi dispatching server 302, or may be regularly or occasionally provided to distributive taxi dispatching server 302 by user device 308. Using the location information, distributive taxi dispatching server 302 may monitor the location of user device 308 (which is presumed to be the location of the user) (331). Distributive taxi dispatching server 302 may monitor and/or determine conditions at the determined location of user device 308. If, according to one or more given algorithms, conditions are such that a person may wish to take a taxi, distributive taxi dispatching server 302 may send an inquiry to user device 308 asking if the user would like a taxi (333). As there are countless algorithms that may be used for this purpose, as would be understood by those of skill in the art, specific algorithms will not be discussed here. User device 308 may prompt the user and receive, via a user interface, a response to the inquiry (334). The response to the inquiry may be provided to distributive taxi dispatching server 302 (335). If the user responds that a taxi is desired, the user may then be prompted for more information about the user's taxi needs, as is discussed in more detail below. In an alternate embodiment (not shown), user device 308 may monitor its own location and current conditions, and may display an inquiry asking if the user would like a taxi, the response to which may be sent to distributive taxi dispatching server 302 (e.g., to signify that a taxi may be needed, to update a passenger profile of the user, etc.).

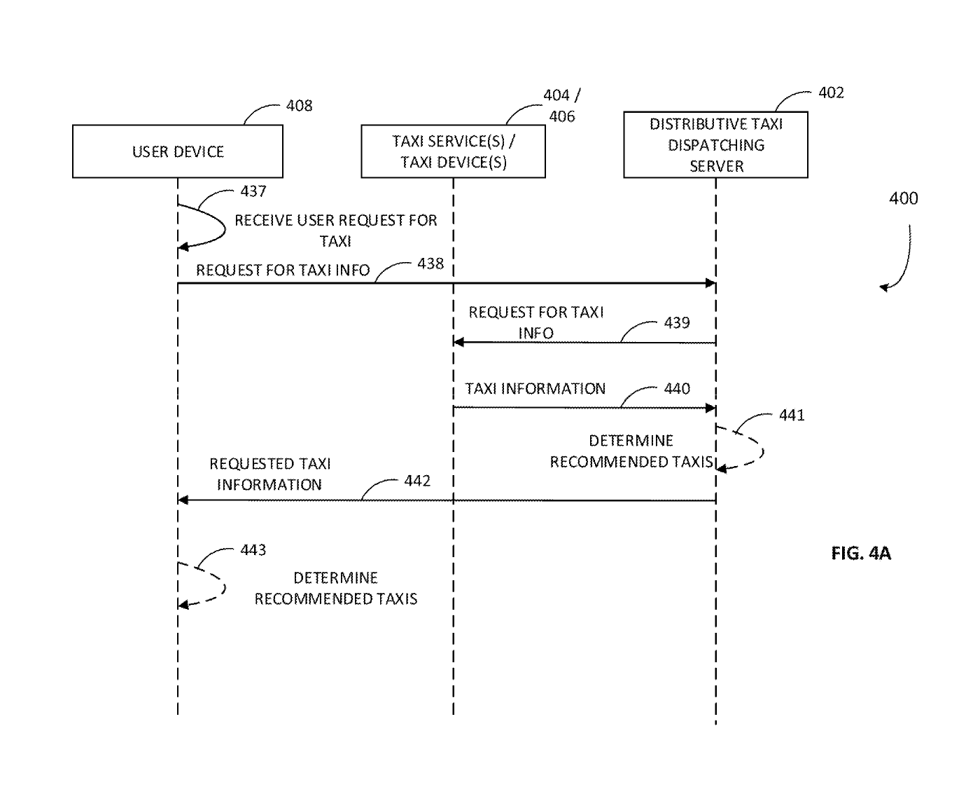

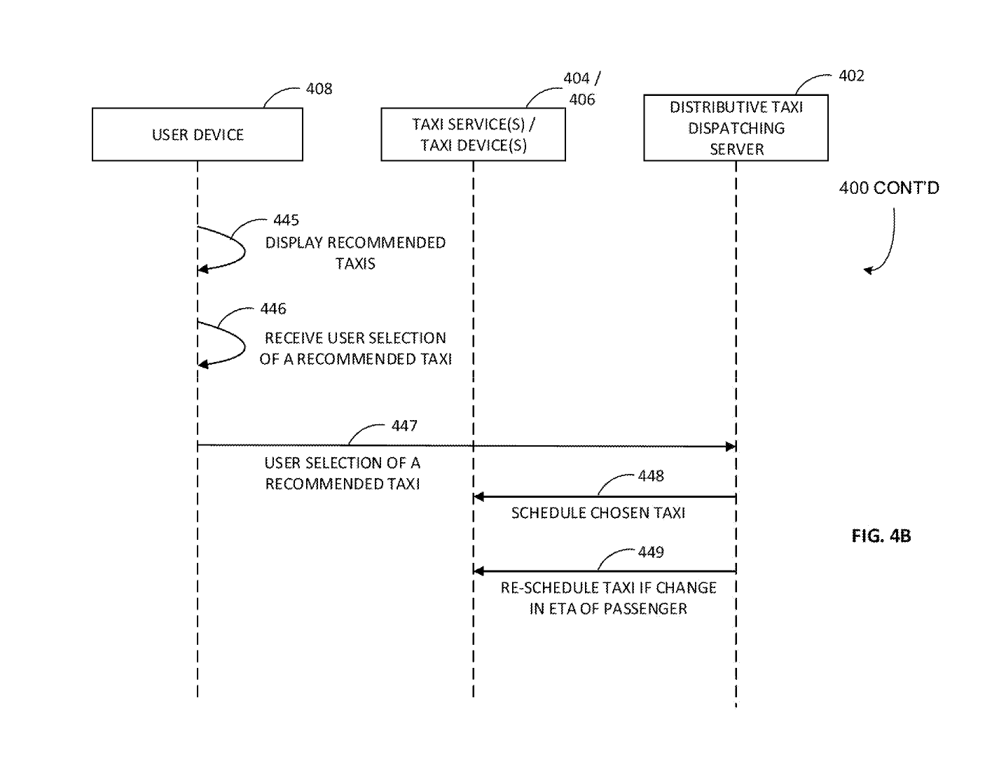

FIGS. 4A-4B illustrate a sequence diagram of an example process flow 400 of a distributive taxi dispatching service, according to an embodiment. With this embodiment, a user may proactively request a taxi, with either an immediate or future need. User device 408 may receive, via a user interface, a user's request for a taxi (437). The request may include, for example, a pick-up location designation and a destination location designation. The user may be prompted to indicate whether the current location of the user device is to be used as the pick-up location designation, in which case the pick-up location designation may be determined by automatic means (e.g., geo-location via GPS coordinates, triangulation, determined locations of devices near the user device, nearby Wi-Fi access points, or other means) as opposed to through input by the user. If not, the user may be prompted to enter a pick-up location designation. If the request is not for an immediate ride, but to schedule one for the future, the user may also be prompted to enter a pick-up date and time. The request may be sent from user device 408 to distributive taxi dispatching server 402 (438). Distributive taxi dispatching server 402 may request availability information, and optionally other information (e.g., fare information, route information, etc.), from computing devices of one or more registered taxi service companies 404 and/or individual registered taxi cabs 406 (439). The taxi availability (and optional other) information may be provided from the computing devices of the one or more taxi service companies 404 and/or individual taxi cabs 406 to distributive taxi dispatching server 402 (440). In an embodiment, distributive taxi dispatching server 402 may determine one or more recommended taxi cabs (441) based on the received taxi availability information and other information (e.g., date/time information (e.g., time of day, day of the week, whether it is a holiday, etc.), location or proximity information regarding the taxi cabs, fare information, route information, current traffic information, etc., obtained from the taxi service companies 404 and/or individual taxi cabs 406 or other sources), historical data related to the user and/or each taxi cab (e.g., collected automatically from monitoring rides of registered users or from direct input from registered users), optionally user preferences as indicated in a passenger profile of the user, etc. Distributive taxi dispatching server 402 may provide a list of the one or more recommended taxi cabs, and associated information, to user device 408 (442). In an embodiment, distributive taxi dispatching server 402 may provide the data (e.g., data that may be unprocessed, unformatted, etc.) associated with the requested taxi information to user device 408 (442), and user device 408 may determine the recommended taxi cabs (443) based on the provided data and, optionally, user preferences. Whether at the distributive taxi dispatching server 402 or user device 408, the determination of recommended taxi cabs may be done using one or more given algorithms. As there are countless algorithms that may be used for this purpose, as would be understood by those of skill in the art, specific algorithms will not be discussed here.

Continuing with FIG. 4B, user device 408 may display the list of recommended taxi cabs (445). The list of recommended taxi cabs may include, for each recommended taxi cab, an identifier for that taxi cab, and one or more of, for example, a recommended route, an estimated fare, a rating. etc. If the request for a taxi was for an immediate taxi, an estimated time of arrival may also be included. The rating may be, but is not to be limited to, for example, a numerical rating (e.g., 1-5), a grade (e.g., A, B, C, D, F, or 0%-100%), an indication of high/medium/low, an object rating (e.g., coloration of five stars), etc. In an embodiment, the rating may be based. on user preferences. A user may be allowed to, via the user interface, select, or click on, a rating in order to “drill down” to see why the taxi cab received that rating. For example, a taxi cab with a rating of 3 out of 5 may have been rated so because, according to historical data collected by distributive taxi dispatching server 402, although the cab would have been otherwise acceptable, 75% of registered users who rode in that cab reported a heavy stench of cigarette smoke, and the user preferences indicated that the user has a low threshold for cigarette smoke.

User device 408 may receive user selection of a recommended taxi cab (446). User device 408 may send the user selection of the recommended taxi cab to distributive taxi dispatching server 402 (447). Distributive taxi dispatching server 402 may schedule (e.g., electronically) the selected taxi cab (448) with the appropriate taxi service or individual taxi cab.

In an embodiment, if the user is not yet located at the designated pick-up location and the designated pick-up time is approaching (e.g., the user is still checking out of a hotel, or the user is on a delayed airplane), distributive taxi dispatching server 402 may detect this and automatically re-schedule the taxi as necessary (449). For example, in an embodiment, distributive taxi dispatching server 402 may determine that although the user may be heading toward the designated pick-up location, the user will not realistically be able to be at the pick-up location at the designated pick-up time. If, for example, it is determined that the difference between the user's estimated time of arrival and the requested pick-up time is greater than a given lateness threshold, distributive taxi dispatching server 402 may alert the taxi cab service and/or driver of a new estimated time of arrival of the passenger and/or reschedule that taxi (or another) altogether. In another embodiment, it may be determined that the user arrived at the designated pick-up location considerably early, in which case distributive taxi dispatching server 402 may be able to alert the taxi cab service and/or driver that the passenger is already ready for pick-up, and/or, if necessary, may reschedule the taxi service accordingly. In another example, the distributive taxi dispatching service may be able to be integrated with one or more travel services that may be able to provide travel information pertinent to the user. For example, the initial request for a taxi may have allowed the user to enter a flight number and arrival time for an airport pick-up. Distributive taxi dispatching server 402 may be able to access one or more travel services and determine that the user's flight was delayed, but is now expected to land at a specified later time. Distributive taxi dispatching server 402 may then reschedule the airport pick-up accordingly. In another example, the distributive taxi dispatching service may be able to be integrated with one or more travel services that store and/or maintain a traveler's itineraries. In this example, distributive taxi dispatching server 402 may be able to determine a user's flight schedule without direct input from the user. In an embodiment, the user device, rather than the distributive taxi dispatching server, may detect: that the user will not arrive at a designated pick-up location in reasonable time and may automatically request that the taxi cab arrival time be updated or that the taxi cab be re-scheduled.

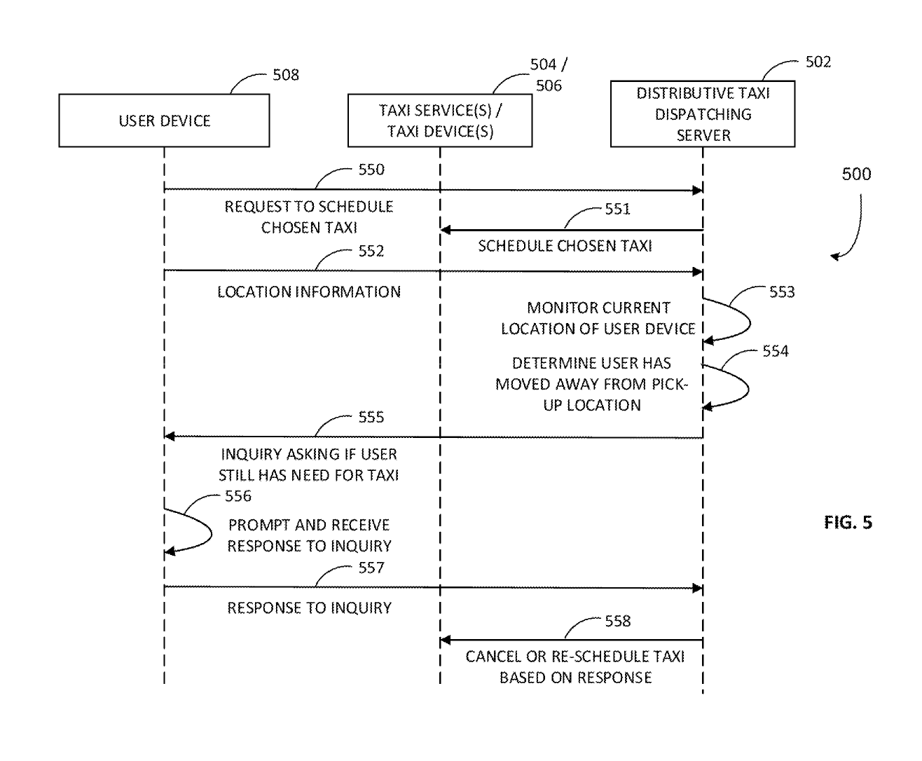

FIG. 5 illustrates a sequence diagram of an example process flow 500 of automated taxi cancellation or rescheduling by a distributive taxi dispatching service, according to an embodiment,. Similar to previously-described embodiments, a user device 508 may send a request to schedule a user-selected taxi to distributive taxi dispatching server 502 (550), and distributive taxi dispatching server 502 may schedule the selected taxi with the appropriate taxi service and/or individual taxi cab (551). As shown in FIG. 5, location information may be provided from user device 508 to distributive taxi dispatching server 502 (552). In embodiments, this location information may be requested by distributive taxi dispatching server 502, or may be regularly or occasionally provided to distributive taxi dispatching server 502 by user device 508. Using the location information, distributive taxi dispatching server 502 may monitor the location of user device 508 (which is presumed to be the location of the user) (553). Distributive taxi dispatching server 502 may determine, based on the monitored location of the user device, that the user has moved away from the pick-up location (e.g., by an amount greater than a given distance threshold) but is not in the scheduled taxi cab (554). Distributive taxi dispatching server 502 may send an inquiry to user device 508 asking if the user still has a need for a taxi (555). User device 508 may prompt the user and receive a response to the inquiry (556), and provide the response to distributive taxi dispatching server 502. Based on the received response, distributive taxi dispatching server 502 may cancel or re-schedule the taxi (558). In an alternate embodiment (not shown), user device 508 may monitor its own location and may determine if the user has moved away from the pick-up location. If the user has moved away from the pick-up location, user device 508 may display an inquiry asking if the user still has a need for a taxi, the response to which may be sent to distributive taxi dispatching server 502.

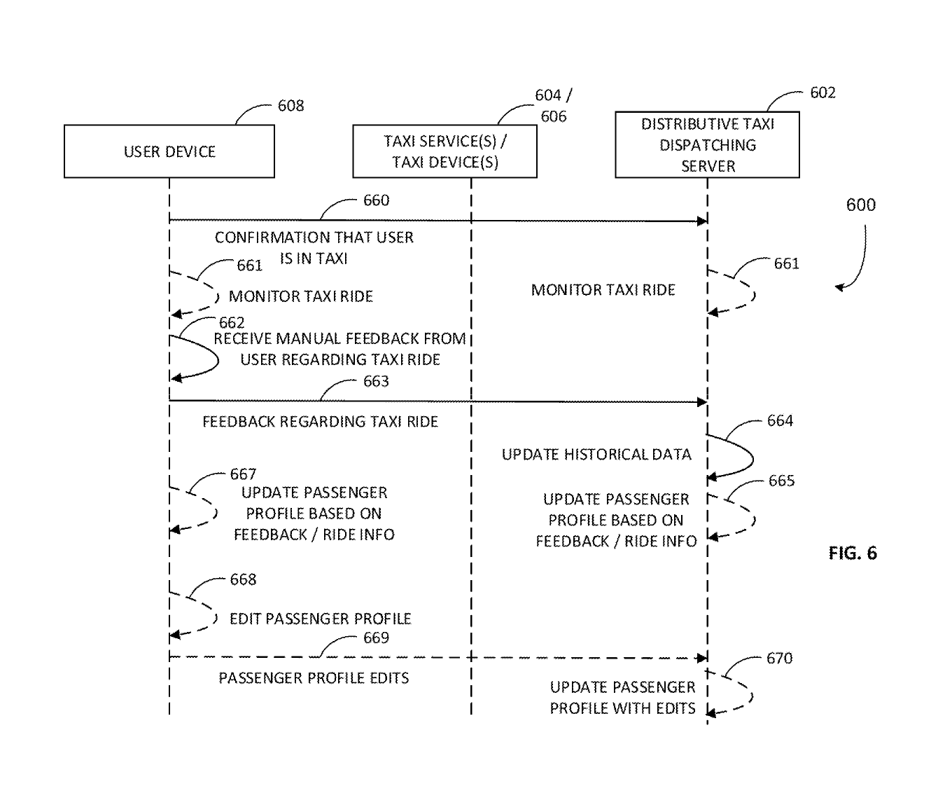

FIG. 6 illustrates a sequence diagram of an example process flow 600 of ride monitoring by a distributive taxi dispatching service, according to an embodiment. Similar to previously-described embodiments, a user device 608 may send confirmation that a user is inside a registered taxi cab to distributive taxi dispatching server 602 (660). In an embodiment, this confirmation may be sent in response to the user selecting the taxi cab on a user interface of user device 608. In another embodiment, this confirmation may be sent as one or more location signals (e.g., determined via geo-location means such as through GPS coordinates, triangulation, or other means) sent from user device 608 to distributive taxi dispatching server 602, from which distributive taxi dispatching server 602 may determine that the user is inside the registered taxi cab (e.g., by comparing location signals of the user device and a location-aware device within the registered taxi cab). In an embodiment, distributive taxi dispatching server 602, user device 608, or both, may monitor the user's ride in the registered taxi cab (661). For example, monitoring may include monitoring locations of the taxi cab, a route taken by the taxi cab, a speed of the taxi cab, duration of travel, aggressiveness of the taxi cab, extent of erratic motion of the taxi cab, etc. This monitoring may be done via monitoring the location of user device 608, the taxi cab (e.g., a device within the taxi cab), or both, and may provide automatically-collected feedback regarding a user's experience in a taxi cab. Distributive taxi dispatching server 602 may further, or instead, receive manually input feedback from the user device regarding the ride in the taxi cab that the user may have input into user device 608 using a user interface (662/663). Distributive taxi dispatching server 602 may update stored historical data regarding the user and/or the taxi cab (664) with the automatically-collected and/or manually entered feedback for subsequent use (e.g., for subsequent determination of a rating for the taxi cab, etc.). If a passenger profile for the user is maintained at the distributive taxi dispatching server 602, distributive taxi dispatching server 602 may update the passenger profile for the user with the automatically-collected and/or manually entered feedback (665). If a passenger profile for the user is maintained at user device 608, user device 608 may update the passenger profile for the user with the automatically-collected and/or manually entered feedback (667). As an example, the automatically-collected and/or manually entered feedback, when taken into account with other historical data, may indicate that the user's threshold for the odor of cigarette smoke may be lessened when in a cab that is time-efficient and has online-payment capability. The passenger profile may be automatically updated to reflect this. In an embodiment in which the user device alone monitors the user's ride, the user device may provide the obtained information regarding the user's ride to the distributive taxi dispatching server for updating historical data and/or a passenger profile, etc.

Turning discussion to the passenger profile, a passenger profile may be initially created for a user upon registration of the user with the distributive taxi dispatching service. For example, during registration, a user may be asked to provide preference information regarding taxi travel, such as, for example, travel information (e.g., travel services used and/or accessible via the distributive taxi dispatching service, payment preferences (e.g., whether the user prefers to make payments using cash, credit cards, online, etc.), billing information (e.g., credit card numbers, business account numbers, etc.), default importance settings regarding time savings versus cost savings, initial threshold settings for such conditions as smoke, filth, odors, comfort, driver aggressiveness, language differences, etc., rating threshold preferences (e.g., a user may not want to see taxi cabs rated less than “3” out of “5”). A passenger profile may be maintained by a distributive taxi dispatching server, a user device, or both. In embodiments, if the distributive taxi dispatching server needs the user profile but does not maintain it, it may request it from the user device, and vice versa. A passenger profile may be automatically updated based on information obtained by, for example, monitoring of the user's taxi rides and other noted user behavior with regard to taxi travel, by the distributive taxi dispatching server, the user device, or both. A passenger profile may he edited by the user. Turning back to FIG. 6, a user may be allowed to edit his or her passenger profile via a user interface of user device 608 (668). If a passenger profile of the user is maintained at distributive taxi dispatching server 602, passenger profile edits may be sent from user device 608 to distributive taxi dispatching server 602 (669) so that it may be updated (670). A user may wish to edit his or her profile if, for example, the user's passenger profile is automatically updated, as discussed above, but the user feels that the updated passenger profile is not an optimal representation of the user's preferences. The user may edit the passenger profile to more accurately reflect the user's preferences.

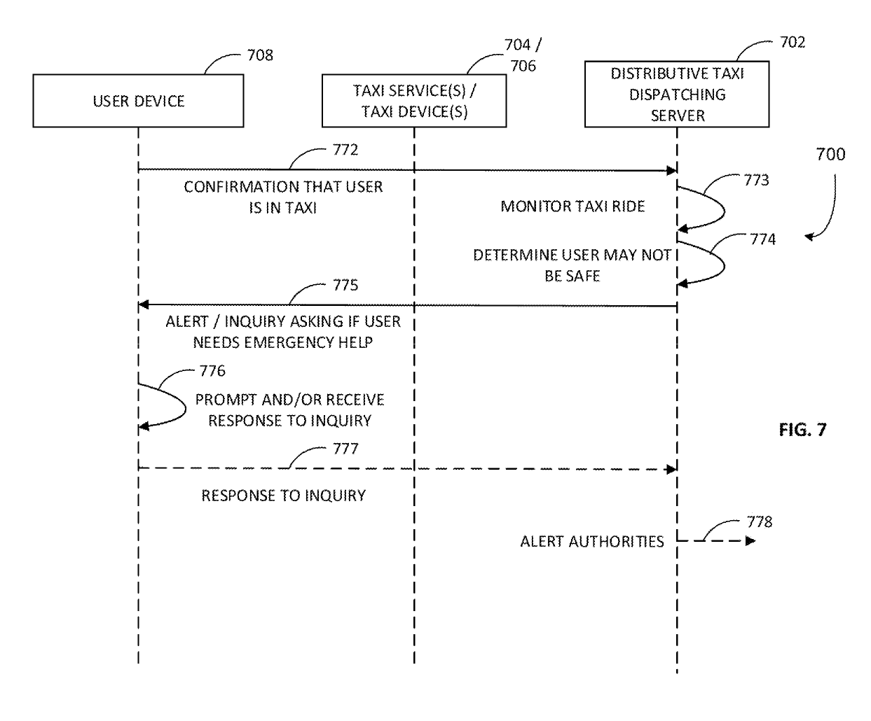

FIG. 7 illustrates a sequence diagram of an example process flow 700 of an emergency alert service of a distributive taxi dispatching service, according to an embodiment. Similar to previously-described embodiments, a user device 708 may send confirmation that a user is inside a registered taxi cab to distributive taxi dispatching server 702 (772), and distributive taxi dispatching server 702 may monitor the user's ride in the registered taxi cab. This monitoring may be done via monitoring the location of user device 708, the taxi cab (e.g., a device within the taxi cab), or both. As discussed previously monitoring may include monitoring locations of the taxi cab, a route taken by the taxi cab, a speed of the taxi cab, duration of travel, aggressiveness of the taxi cab, extent of erratic motion of the taxi cab, etc. Based on the monitoring of the user's ride, distributive taxi dispatching server 702 may determine that the user may not be safe (774). For example, distributive taxi dispatching server 702 may determine that there is an indication of for example, speeding beyond a given speed threshold, erratic driving, deviation from an expected route beyond a given deviation threshold, location in a designated unsafe zone, etc. Distributive taxi dispatching server 702 may send, to user device 708, an alert stating that the user may be unsafe and/or an inquiry asking if the user is in need of emergency help (775). User device 708 may display the alert and/or prompt the user for a response to the inquiry as to whether emergency help is needed (776). User device 708 may send the user's response to the inquiry to distributive taxi dispatching server 702 (777). If the user responds that emergency help is needed, or if distributive taxi dispatching server 702 receives no response to the inquiry within a given timeframe or time threshold, distributive taxi dispatching server 702 may alert authorities (778). In an example, distributive taxi dispatching server 702 may alert authorities with the nature of the emergency, the location, and/or the identification of the taxi cab, the user, or both.

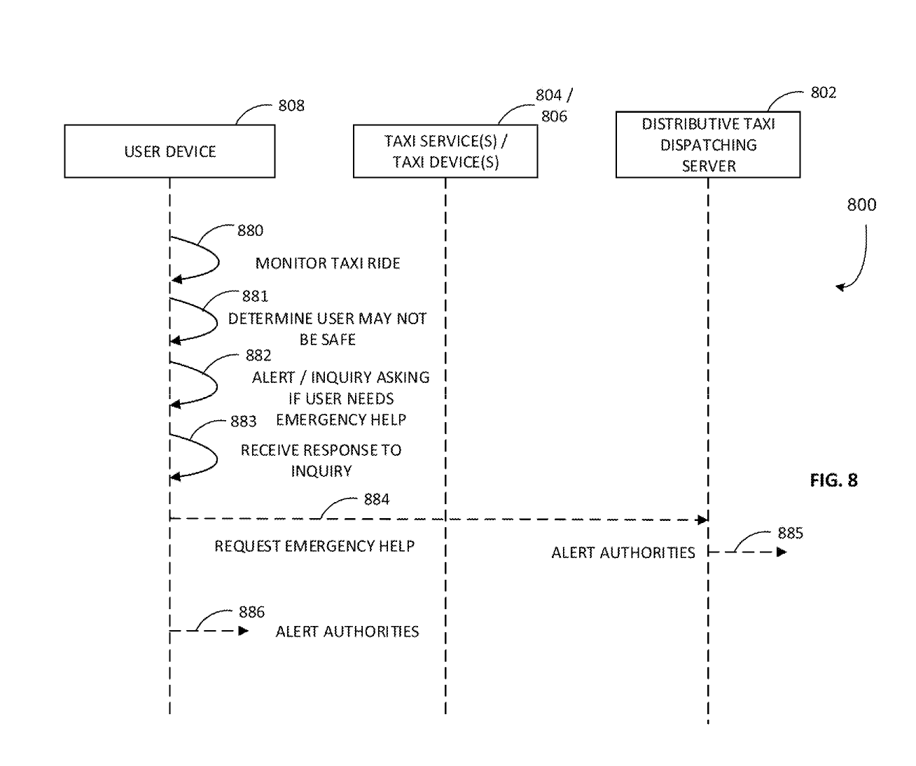

FIG. 8 illustrates a sequence diagram of an example process flow 800 of an emergency alert service of a distributive taxi dispatching service, according to an alternate embodiment. Instead of a distributive taxi dispatching server as described above with reference to FIG. 7, user device 808 may monitor a user's ride in a registered taxi cab (880). This monitoring may be done via monitoring the location of user device 808, the taxi cab (e.g., a device within the taxi cab), or both. As discussed previously, monitoring may include monitoring locations of the taxi cab, a route taken by the taxi cab, a speed of the taxi cab, duration of travel, aggressiveness of the taxi cab, extent of erratic motion of the taxi cab, etc. Based on the monitoring of the user's ride, user device 808 may determine that the user may not be safe (881). For example, user device 808 may determine that there is an indication of, for example, speeding beyond a given speed threshold, erratic driving, deviation from an expected route beyond a given deviation threshold, location in a designated unsafe zone, etc. User device 808 may display an alert stating that the user may be unsafe and/or may display a prompted inquiry asking if the user is in need of emergency help (882). User device 808 may receive a response to the inquiry as to whether emergency help is needed (883). If the user responds that emergency help is needed, or if user device 808 receives no response to the inquiry within a given timeframe or time threshold, user device 808 may send a request for emergency help. In an embodiment, user device 808 may send a request for emergency help to the distributive taxi dispatching server 802 (884), and distributive taxi dispatching server 802 may alert authorities (885). In another embodiment, user device 808 may directly alert authorities (886). In an example, the authorities may be alerted to the nature of the emergency, the location, and/or the identification of the taxi cab, the user, or both.

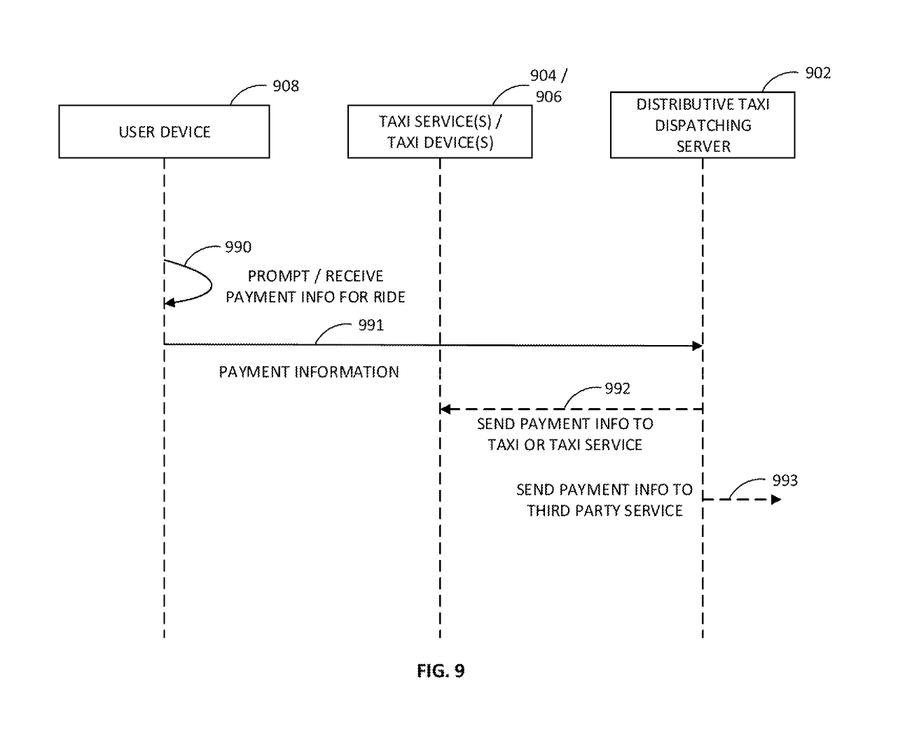

FIG. 9 illustrates a sequence diagram, of an example process flow 900 of an online payment service of a distributive taxi dispatching service, according to an embodiment. Once an occupied taxi cab arrives at the user's destination, or if there is indication that the ride is otherwise over, user device 908 may prompt the user for online payment 990. In embodiments, the conclusion of a ride may be determined by either user device 908 or distributive taxi dispatching server 902 by determining that user device 908, the taxi cab device 906, or both, are located at a known destination location. In other embodiments, the conclusion of a ride may be indicated manually by the user at user device 908 and/or by the taxi cab driver at taxi cab device 906. The user may he prompted to choose the type of payment being made (e.g., cash, credit card, online payment service, business account, personal account, etc.), and may optionally be prompted for a tip amount. Depending on the type of payment, the user may also be prompted for further information (e.g., a password, a credit card number, etc.). The payment information may be provided by user device 908 to distributive taxi dispatching server 902 (991), from Which the payment information may be sent to the account of an appropriate registered taxi service company or individual taxi cab driver (992), or to a third party payment service (993) for appropriate disbursement. In an alternate embodiment (not shown), user device 908 may directly provide the payment information to the account of the appropriate registered taxi service company or individual taxi cab driver, or to a third party payment service.

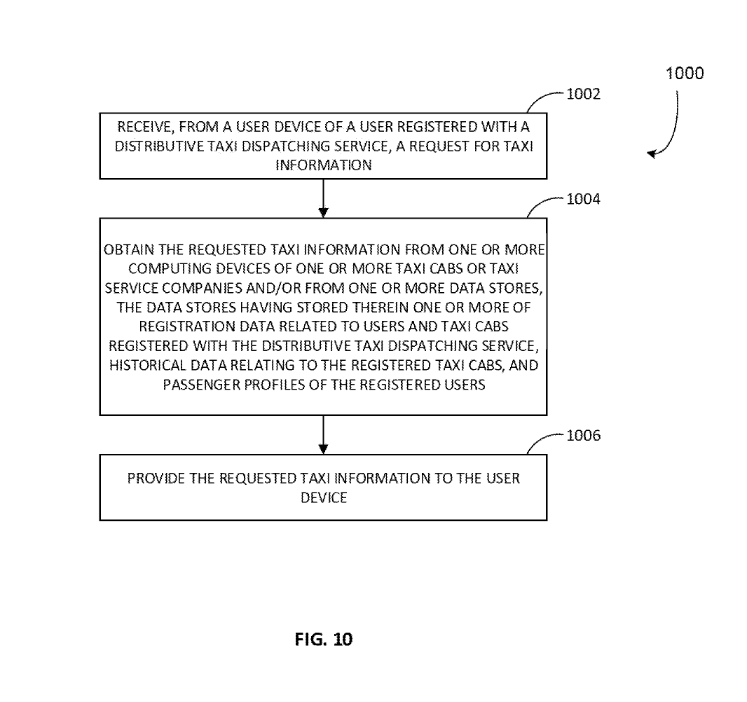

FIGS. 10-19 are flow charts illustrating example process flows of a distributive taxi dispatching service, from the perspective of a distributive taxi dispatching server, according to various embodiments. The features depicted are similar to a subset of those discussed earlier, but are from a single perspective (i.e., from the perspective of a distributive taxi dispatching server).

FIG. 10 is an example process flow 1000 of providing a distributive taxi dispatching service, from the perspective of a distributive taxi dispatching server, according to an embodiment. At 1002, a request for taxi information may be received from a computing device of a user registered with the distributive taxi dispatching service. The request for information may be, for example, a request for information about a nearby taxi cab that a user may wish to take, a request for immediate pick-up by a taxi cab registered with the distributive taxi dispatching service, a request for future pick-up by a taxi cab registered with the distributive taxi dispatching service, etc. At 1004, the requested taxi information may be obtained. The requested taxi information may be obtained from one or more computing devices of one or more taxi cabs or taxi service companies and/or from one or more data stores resident with, or accessible by, the distributive taxi dispatching server. The data stores may include, for example, registration data related to users and/or taxi cabs registered with the distributive taxi dispatching service, historical data relating to the registered taxi cabs or users, passenger profiles of registered users, etc. At 1006, the requested taxi information may be provided to the user device. The provided taxi information may depend on the type of request. For example, if the request was for information about a nearby taxi cab that a user may wish to take, the provided information may include, for example, verification whether that taxi cab is registered with the distributive taxi dispatching service. The provided information may also include, for example, an identifier of that taxi cab, a rating of that taxi cab, etc. If the original request was for immediate or future pick-up by a taxi cab registered with the distributive taxi dispatching service, the provided information may include, for example, a list of one or more recommended taxi cabs registered with the distributive taxi dispatching service. The provided information may also include, for each recommended taxi cab, information such as a cab identifier, an estimated time of arrival, a recommended route, an estimated fare, a rating, etc. In an embodiment, the provided taxi information may include the data (e.g., unprocessed, unformatted, etc.) relevant to the original request, where a receiving user device is expected to use the data to further respond to the request (e.g., determine the one or more recommended taxi cabs, etc.).

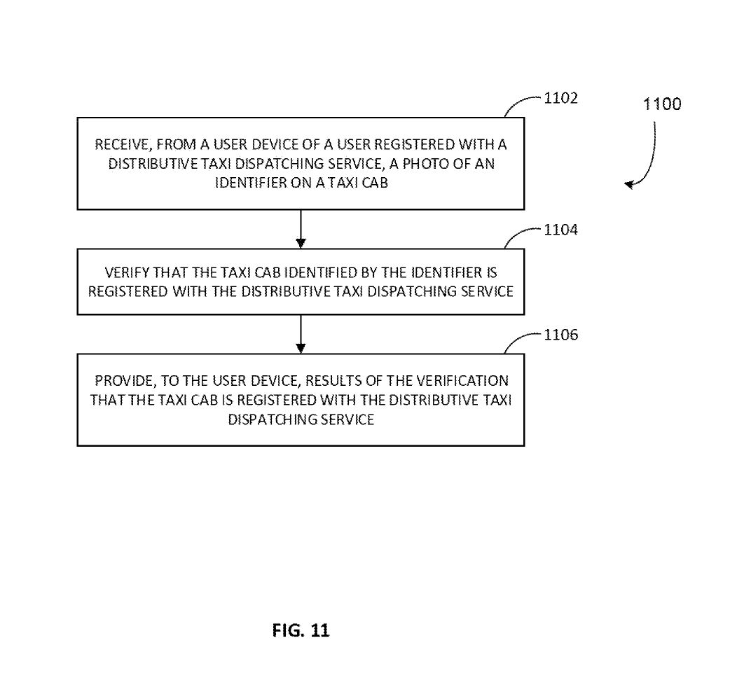

FIG. 11 is an example process flow 1100 of verification of registration of a taxi cab by a distributive taxi dispatching service, from the perspective of a distributive taxi dispatching server, according to an embodiment. At 1102, a photo of an identifier on a taxi cab may be received from a computing device of a user registered with the distributive taxi dispatching service. The photo may be, for example, a photo of a license plate, a cab identification tag or number, a barcode, etc. At 1104, the distributive taxi dispatching server may verify whether the taxi cab identified by the identifier is registered with the distributive taxi dispatching service. For example, the distributive taxi dispatching server may compare the identifying information with stored registration data regarding registered taxi cabs to look for a match. At 1106, results of the verification are provided to the user device. For example, if the taxi cab is not registered with the distributive taxi dispatching service, this information may be provided to the user device. If the taxi cab is registered with the distributive taxi dispatching service, this information may be provided to the user device. In this case, other information may also be provided to the user device, such as, for example, an identifier of that taxi cab, a rating of that taxi cab, etc.

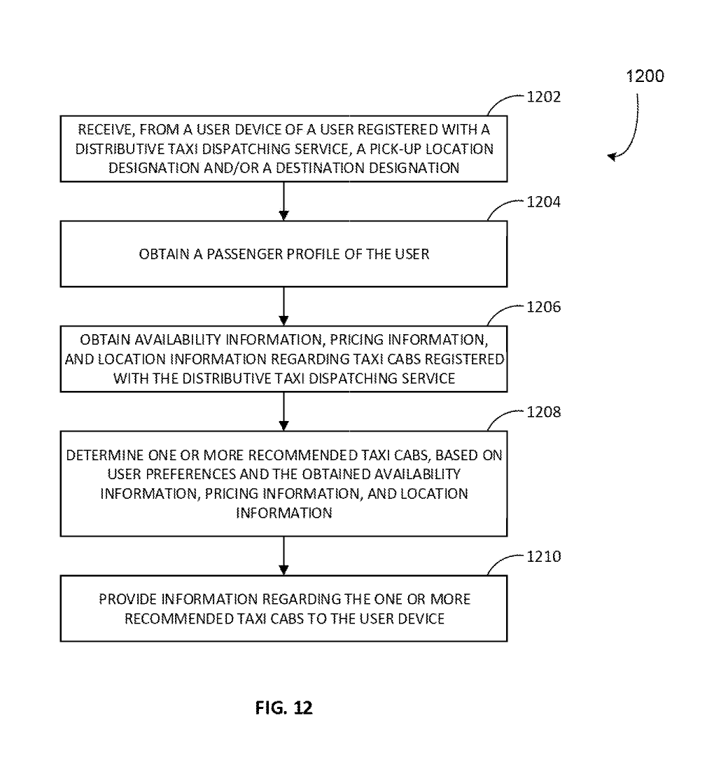

FIG. 12 is an example process flow 1200 of providing taxi cab information by a distributive taxi dispatching service, from the perspective of a distributive taxi dispatching server, according to an embodiment. At 1202, a pick-up location and/or destination designation may be received from a computing device of a user registered with the distributive taxi dispatching service, for example, as part of a request for immediate pick-up by a registered taxi cab. At 1204, a passenger profile of the user may be obtained or accessed. In an embodiment, the passenger profile may be obtained or accessed from a data store resident with, or accessible by, the distributive taxi dispatching server, if, for example the passenger profile is maintained by the distributive taxi dispatching server. In another embodiment, the passenger profile may be requested and received from the user device, if, for example, the passenger profile is maintained by the user device. At 1206, information regarding taxi cabs registered with the distributive taxi dispatching service may be obtained. The taxi cab information may include, for example, availability information, pricing or fare information, location information, etc. The taxi cab information may be obtained, for example, from computing devices of taxi cab services or individual taxi cabs and/or from one or more data stores resident with, or accessible by, the distributive taxi dispatching server. At 1208, one or more recommended taxi cabs may be determined based on user preferences from the passenger profile of the user and/or the obtained taxi cab information. This determination may be made using one or more algorithms. As there are countless algorithms that may be used for this purpose, as would be understood by those of skill in the art, specific algorithms will not be discussed here. At 1210, information regarding the one or more recommended taxi cabs may be provided to the user device. The provided information may include, for example, a list of one or more recommended taxi cabs registered with the distributive taxi dispatching service. The provided information may also include, for each recommended taxi cab, information such as a cab identifier, an estimated time of arrival, a recommended route, an estimated fare, a rating, etc.

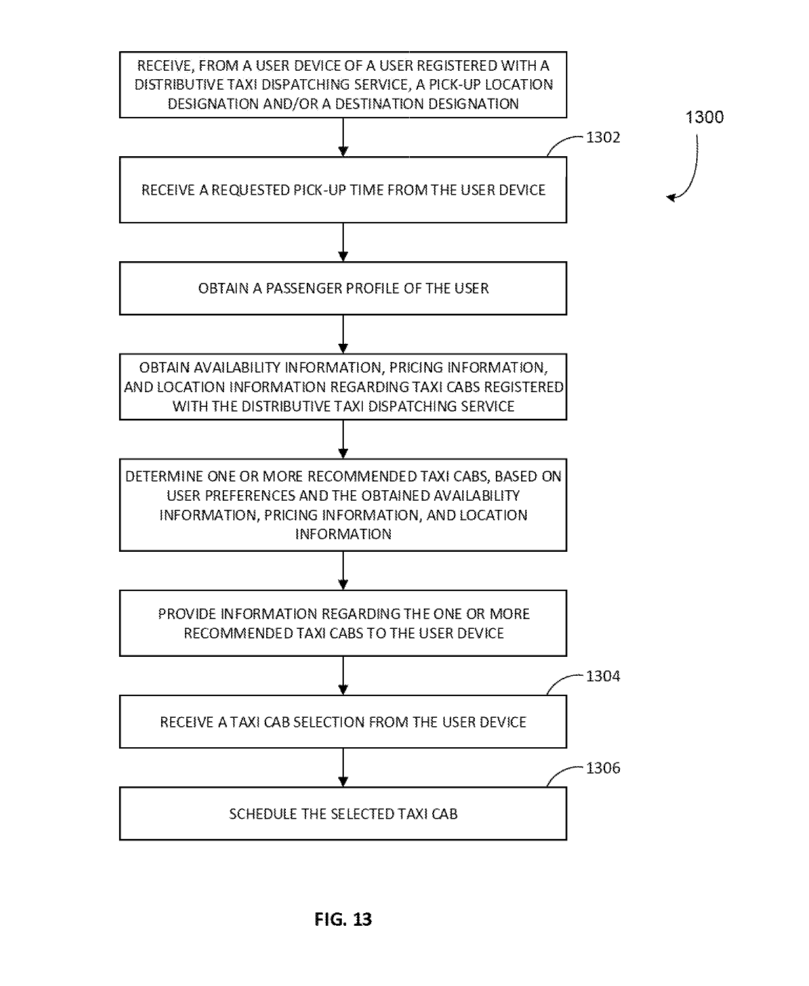

FIG. 13 is an example process flow 1300 of providing taxi cab information by a distributive taxi dispatching service, from the perspective of a distributive taxi dispatching server, according to an embodiment. Flow 1300 is similar to flow 1200 of FIG. 12, with some exceptions. At 1302, in addition to a pick-up location and/or destination designation, a requested pick-up date and time may be received from a computing device of a user registered with the distributive taxi dispatching service. This may be, for example, as part of a request for immediate or future pick-up by a registered taxi cab. The requested pick-up time may be “immediately”, or may be a date and/or time in the future. Similar to the flow shown in FIG. 12, one or more recommended taxi cabs may be determined and provided to the user device. In flow 1300, the process continues at 1304, where a taxi cab selection may be received from the user device. At 1306, the selected taxi cab may be scheduled. For example, the distributive taxi dispatching server may automatically schedule the selected taxi cab via communication with a computing device of the taxi service associated with the selected taxi cab, or a computing device of the taxi cab itself (e.g., in the case of a sole privately owned taxi cab that may be registered with the distributive taxi dispatching service).

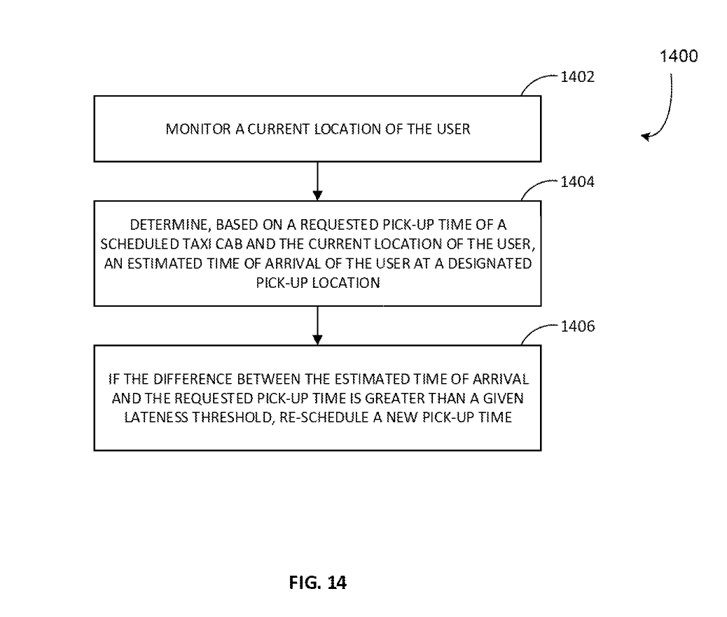

FIG. 14 is an example process flow 1400 of monitoring a passenger pick-up by a distributive taxi dispatching service, from the perspective of a distributive taxi dispatching server, according to an embodiment. At 1402, a current location of a registered user who has requested pick-up by a registered taxi cab may be monitored. For example, the current location may be requested from a user device of the user by a distributive taxi dispatching server, or may be regularly or occasionally provided to distributive taxi dispatching server by the user device. The location information may include, for example, GPS coordinates, or other coordinates or types of location information. At 1404, an estimated time of arrival of the user at a designated pick-up location may be determined based on a requested pick-up time of a scheduled taxi cab and the current location of the user. The distributive taxi dispatching server may also determine a difference between the estimated time of arrival of the user and the requested pick-up time that may indicate that the user will be late to arrive at the pick-up location. At 1406, if the difference between the estimated time of arrival and the requested pick-up time is greater than a given lateness threshold, a new pick-up time may be scheduled. For example, in this case, the distributive taxi dispatching server may alert the taxi cab service and/or taxi cab driver of a new estimated time of arrival of the passenger, or may reschedule the selected taxi (or another taxi) altogether.

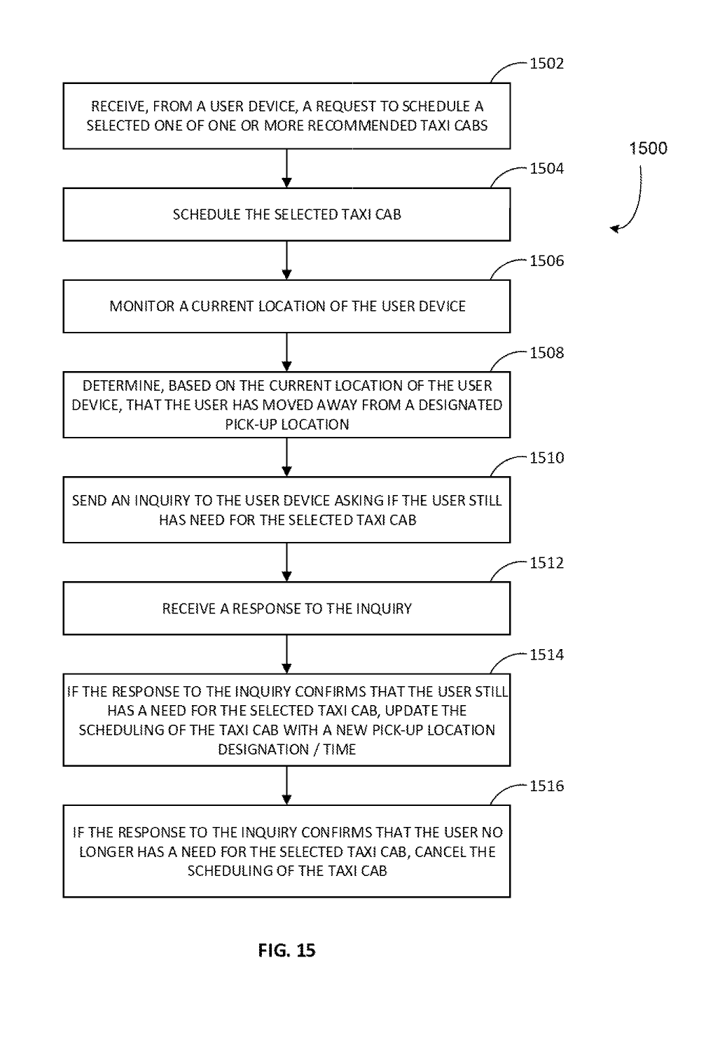

FIG. 15 is an example process flow 1500 of monitoring a passenger pick-up by a distributive taxi dispatching service, from the perspective of a distributive taxi dispatching server, according to an embodiment. At 1502, a request to schedule a selected taxi cab is received from a computing device of a registered user of the distributive taxi dispatching service. At 1504, the selected taxi cab is scheduled. At 1506, a current location of the user device is monitored. At 1508, the distributive taxi dispatching server may determine, based on the current location of the user device, that the user has moved away from the designated pick-up location. For example, the distributive taxi dispatching server may determine that the user has moved more than a given threshold distance away from the pick-up location. At 1510, the distributive taxi dispatching server may send an inquiry to the user device asking of the user still has a need for the selected taxi cab. At 1512, a response to the inquiry is received. At 1514, if the response to the inquiry confirms that the user still has a need for the selected taxi cab, the distributive taxi dispatching server may update the scheduling of the taxi cab with a new pick-up location designation and optionally a new time. At 1516, if the response to the inquiry confirms that the user no longer has a need for the selected taxi cab, the distributive taxi dispatching server may cancel the scheduling of the taxi cab. The updating of the scheduling or the cancellation of the scheduling may be automatically done via communication with a computing device of the taxi service associated with the selected taxi cab, or a computing device of the taxi cab itself

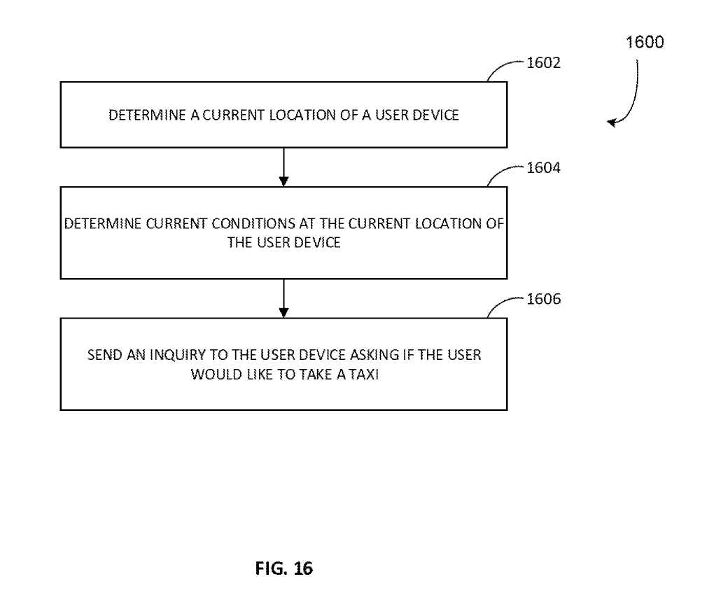

FIG. 16 is an example process flow 1600 of polling a potential passenger by a distributive taxi dispatching service, from the perspective of a distributive taxi dispatching server, according to an embodiment. At 1602, a current location of a registered user may be determined. For example, the current location may be requested from a user device of the user by the distributive taxi dispatching server, or may be regularly or occasionally provided to distributive taxi dispatching server by the user device. The location information may include, for example, GPS coordinates, or other coordinates or types of location information. At 1604, current conditions (e.g., weather conditions, traffic conditions, construction conditions, environmental conditions, etc.) at the current location of the user device are determined. For example, the current conditions may be retrieved via communication with accessible external data sources (e.g., weather data sources, traffic data sources, etc.). The current location of the user device may indicate that the user may be traveling, and the current conditions there may indicate that the user may appreciate a ride. At 1606, an inquiry may be sent to the user device asking if the user would like to take a taxi cab. If the user responds with a “yes”, the user may be prompted to request and/or select a recommended taxi cab as described elsewhere herein.

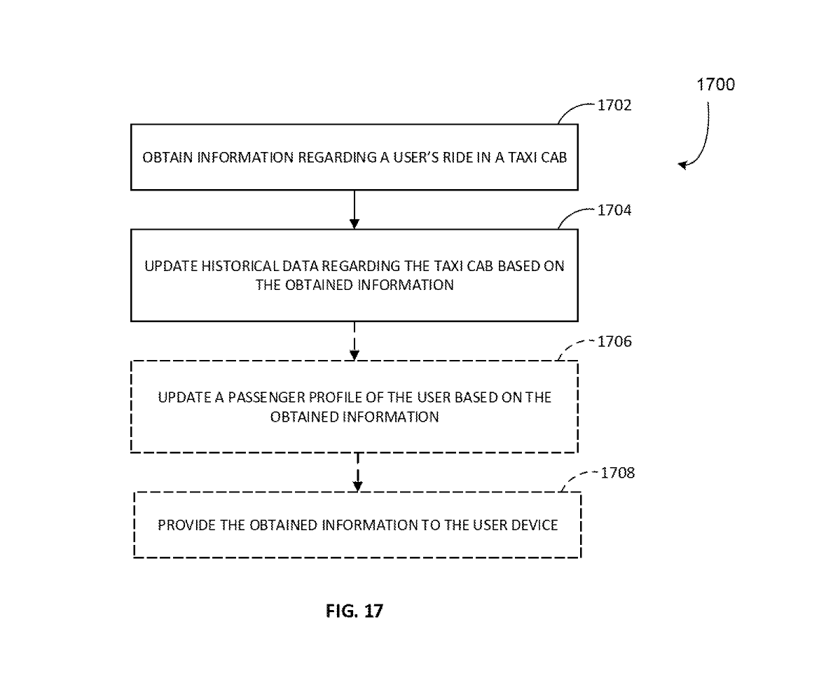

FIG. 17 is an example process flow 1700 of managing feedback regarding a taxi ride by a distributive taxi dispatching service, from the perspective of a distributive taxi dispatching server, according to an embodiment. At 1702, information is obtained regarding a user's ride in a taxi cab registered with the distributive taxi dispatching service. In an embodiment, the distributive taxi dispatching server may automatically obtain ride feedback by monitoring the user's ride in the registered taxi cab. For example, monitoring may include monitoring locations of the taxi cab, a route taken by the taxi cab, a speed of the taxi cab, duration of travel, aggressiveness of the taxi cab, extent of erratic motion of the taxi cab, etc. This monitoring may be done via monitoring the location of a user device of the user, the taxi cab (e.g., a device within the taxi cab), or both. In an embodiment, the distributive taxi dispatching server may additionally, or instead, receive manually input feedback from the user device regarding the ride in the taxi cab that the user may have input into the user device via a user interface. At 1704, historical data regarding the taxi cab and/or user may be updated based on the obtained information regarding the taxi ride. Optionally, at 1706, if a passenger profile for the user is maintained at the distributive taxi dispatching server, distributive taxi dispatching server may update the passenger profile for the user with the obtained feedback regarding the taxi ride. As an example, the automatically-collected and/or manually entered feedback, when taken into account with other historical data, may indicate that the user's thresholds regarding taxi cabs may have changed or may need adjustment. The passenger profile for the user may be automatically updated to reflect this. In an embodiment, at 1708, if a passenger profile for the user is maintained at the user device, the distributive taxi dispatching server may provide the obtained information regarding the taxi ride to the user device for updating of the passenger profile.

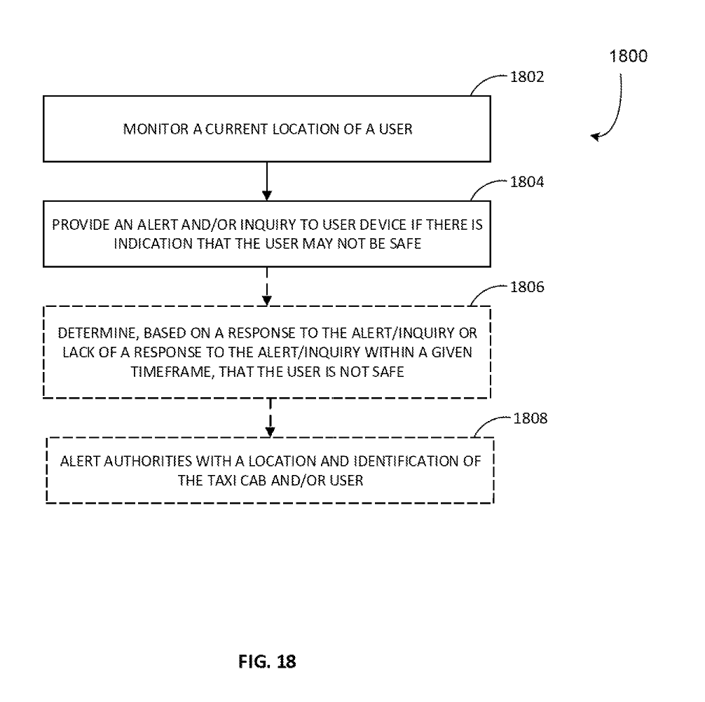

FIG. 18 is an example process flow 1800 of monitoring a taxi ride by a distributive taxi dispatching service, from the perspective of a distributive taxi dispatching server, according to an embodiment. At 1802, a current location of a user in a registered taxi cab may he monitored. This monitoring may be done by monitoring the location of a user device of the user, the taxi cab (e.g., via a device within the taxi cab, receiving updates from a taxi cab service, etc.), or both. At 1804, an alert may be provided to the user device if there is indication that the user may not be safe. For example, the distributive taxi dispatching server may determine that there is an indication of, for example, speeding beyond a given speed threshold, erratic driving, deviation from an expected route beyond a given deviation threshold, location in a designated unsafe zone. etc. The distributive taxi dispatching server may send, to the user device, an alert stating that the user may be unsafe and/or an inquiry asking if the user is in need of emergency help. Optionally, if an inquiry is sent, at 1806, based on a response to the inquiry or a lack of a response to the inquiry within a given timeframe or time threshold, the distributive taxi dispatching server may determine that the user is indeed not safe. At 1808, the distributive taxi dispatching server may alert authorities for help. In an example, the distributive taxi dispatching server may alert authorities with the nature of the emergency, the location, and/or the identification of the taxi cab, the user, or both.

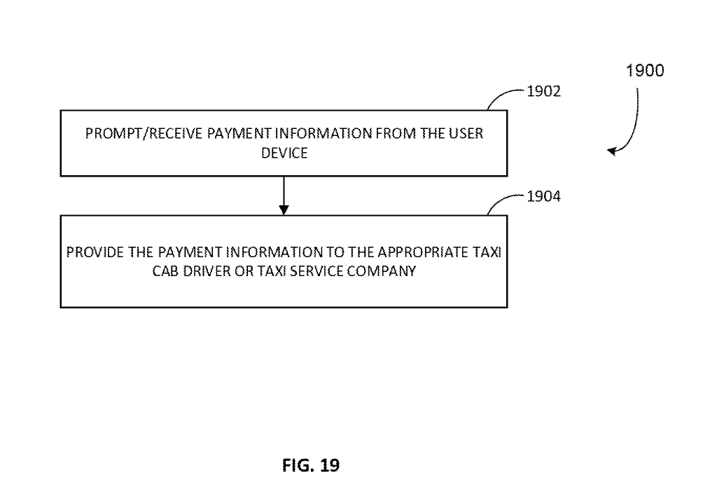

FIG. 19 is an example process flow 1900 of receiving fare payment by a distributive taxi dispatching service, from the perspective of a distributive taxi dispatching server, according to an embodiment. At 1902, payment information may be prompted for and received by it user device of a user. For example, the user may be prompted to choose the type of payment being made (e.g., cash, credit card, online payment service, business account, personal account, etc.), and may optionally be prompted for a tip amount. Depending on the type of payment, the user may also be prompted for further information (e.g., a password, a credit card number, etc.). At 1904, the payment information may be provided to the appropriate taxi cab driver or taxi service company. For example, the payment information may be sent to an account of an appropriate registered taxi service company or individual taxi cab driver, or to a third party payment service that may provide the appropriate disbursement of the payment.

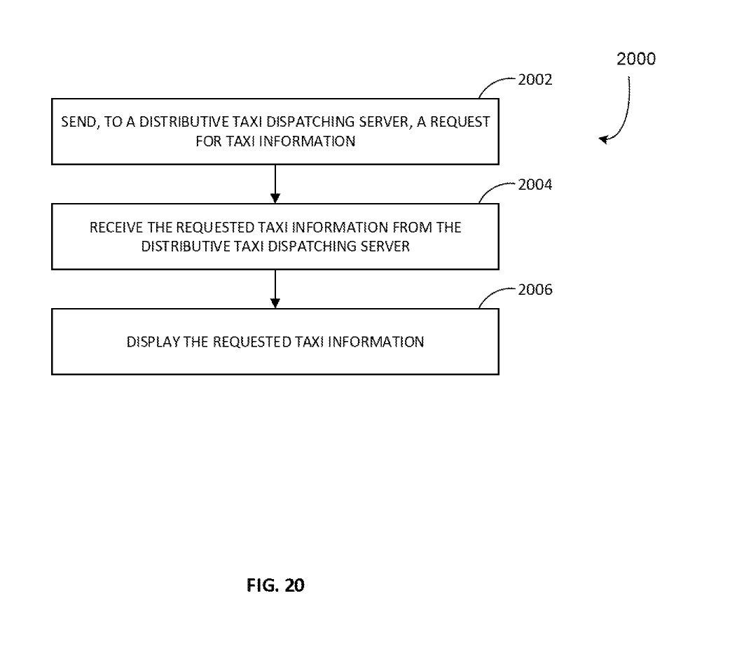

FIGS. 20-27 are flow charts illustrating example process flows of a distributive taxi dispatching service, from the perspective of a user device of a user registered with the distributive taxi dispatching service, according to various embodiments. The features depicted are similar to a subset of those discussed earlier, but are from a single perspective (i.e., from the perspective of the user device).

FIG. 20 is an example process flow 2000 of providing a distributive taxi dispatching service, from the perspective of a user device of a user registered with the distributive taxi dispatching service, according to an embodiment. At 2002, a request for taxi information may he sent to a distributive taxi dispatching server. The request for information may be, for example, a request for information about a nearby taxi cab that the user may wish to take, a request for immediate pick-up by a taxi cab registered with the distributive taxi dispatching service, a request for future pick-up by a taxi cab registered with the distributive taxi dispatching service, etc. If the request for information is for information about a nearby taxi cab, the request the information may include, for example, a photo or scan of an identifier on the taxi cab (e.g., a license plate, an identification code or number, a barcode, etc.), a partially or fully decoded identifier from a photo or scan of the identifier, etc. A request for taxi information may include information from a passenger profile of the user, if a passenger profile is maintained at the user device. At 2004, the requested taxi information may be received from the distributive taxi dispatching server. The received taxi information may depend on the type of request. For example, if the request was for information about a nearby taxi cab that the user may wish to take, the received information may include, for example, verification whether that taxi cab is registered with the distributive taxi dispatching service. The received information may also include, for example, an identifier of that taxi cab, a rating of that taxi cab, etc. If the original request was for immediate or future pick-up by a taxi cab registered with the distributive taxi dispatching service, the received information may include, for example, a list of one or more recommended taxi cabs registered with the distributive taxi dispatching service. The received information may also include, for each recommended taxi cab, information such as a cab identifier, an estimated time of arrival, a recommended route, an estimated fare, a rating, etc. At 2006, the requested taxi information may be displayed. In an embodiment, the user may be allowed to, via the user interface of the user device, select, or click on, a displayed rating in order to “drill down” to see why the taxi cab received that rating. In an embodiment, the provided taxi information may include the data relevant to the original request (e.g., data that may be unprocessed or unformatted) that may be used by the receiving user device to further respond to the request (e.g., determine the one or more recommended taxi cabs, etc.). In an embodiment, the user may select a taxi cab from the list of taxi cabs to indicate the taxi cab the user has chosen to schedule.

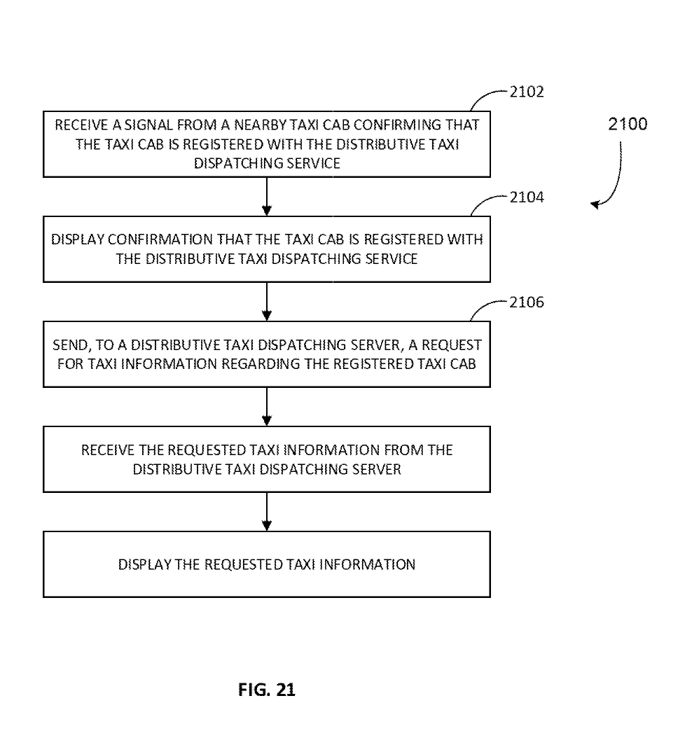

FIG. 21 is an example process flow 2100 of verification of registration of a taxi cab by a distributive taxi dispatching service, from the perspective of a user device of a user registered with the distributive taxi dispatching service, according to an embodiment. Flow 2100 is similar to flow 2000, except that prior to sending a request for information, at 2102, a signal (e.g., a near-field Wi-Fi signal, or other near-field signal) may be received from a nearby taxi cab (or possibly multiple nearby taxi cabs) confirming that the taxi cab is registered with the distributive taxi dispatching service. The signal may be received in response to a user request for information regarding nearby taxi cabs. At 2104, confirmation that the taxi cab is registered with the distributive taxi dispatching service may be displayed. At 2106, a request for taxi information regarding the registered taxi cab may be sent to a distributive taxi dispatching server.

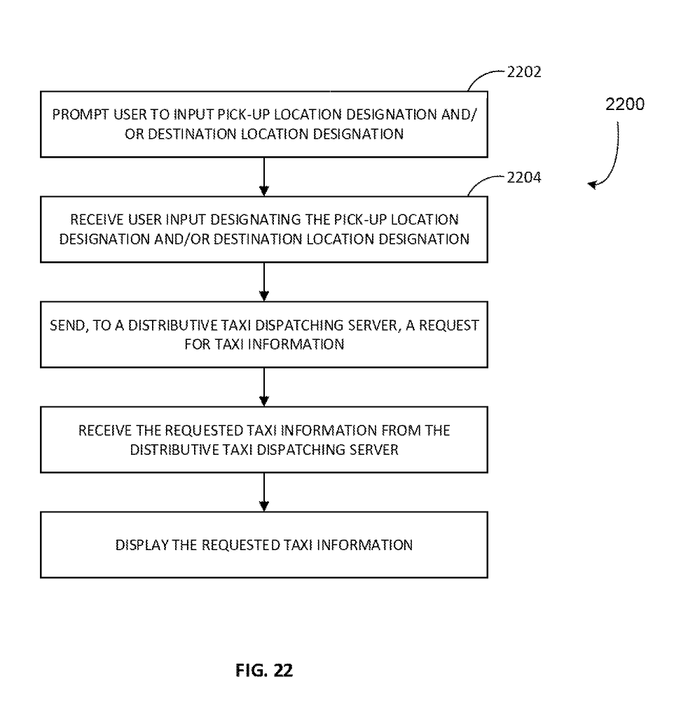

FIG. 22 is an example process flow 2200 of requesting taxi cab information by a user device of a user registered with the distributive taxi dispatching service, from the perspective of the user device, according to an embodiment. Flow 2200 is similar to flow 2000, except that prior to sending a request for information, at 2202/2204, the user device may prompt the user for, and receive, input of a pick-up location designation and/or a destination location designation. This embodiment may be relevant to the situation where a user would like to request an immediate or a future taxi. The pick-up location designation and/or designation location designation may be made by the user in a variety of ways (e.g., typed input, placing one or more pins on a map, voice recognition, retrieval of known itinerary information, etc.).

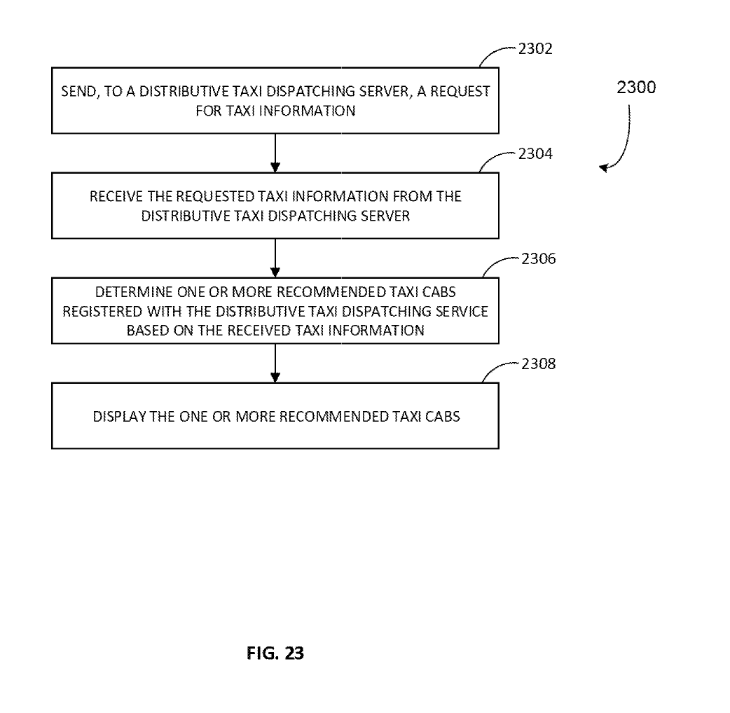

FIG. 23 is an example process flow 2300 of providing taxi cab information by a distributive taxi dispatching service, from the perspective of a user device of a user registered with the distributive taxi dispatching service, according to an embodiment. In this embodiment, the user device may request and receive taxi cab information and determine from the received information one or more recommended taxi cabs to display to the user. At 2302 a request for taxi information may be sent to a distributive taxi dispatching server. The request may include, for example, a requested pick-up location designation and/or time and optionally a destination location designation. At 2304, the requested taxi information may be received from the distributive taxi dispatching server. At 2306, one or more recommended taxi cabs registered with the distributive taxi dispatching service may be determined based on the received taxi information. This determination may be made using one or more algorithms. As there are countless algorithms that may be used for this purpose, as would he understood by those of skill in the art, specific algorithms will not be discussed here. At 2308, the one or more recommended taxi cabs may be displayed. For example, a list of recommended taxi cabs may be displayed. The list of recommended taxi cabs may include, for each recommended taxi cab, an identifier for that taxi cab, and one or more of, for example, a recommended route, an estimated fare, a rating, etc. If the request for a taxi was for an immediate taxi, an estimated time of arrival may also be included. The rating may be, but is not to be limited to, for example, a numerical rating (e.g., 1-5), a grade (e.g., A, B, C, D, F, or 0%-100%), an indication of high/medium/low, an object rating (e.g., coloration of five stars), etc. In an embodiment, the rating may be based on user preferences. In an embodiment, the user may be allowed to, via the user interface of the user device, select, or click on, a rating in order to “drill down” to see why the taxi cab received that rating.

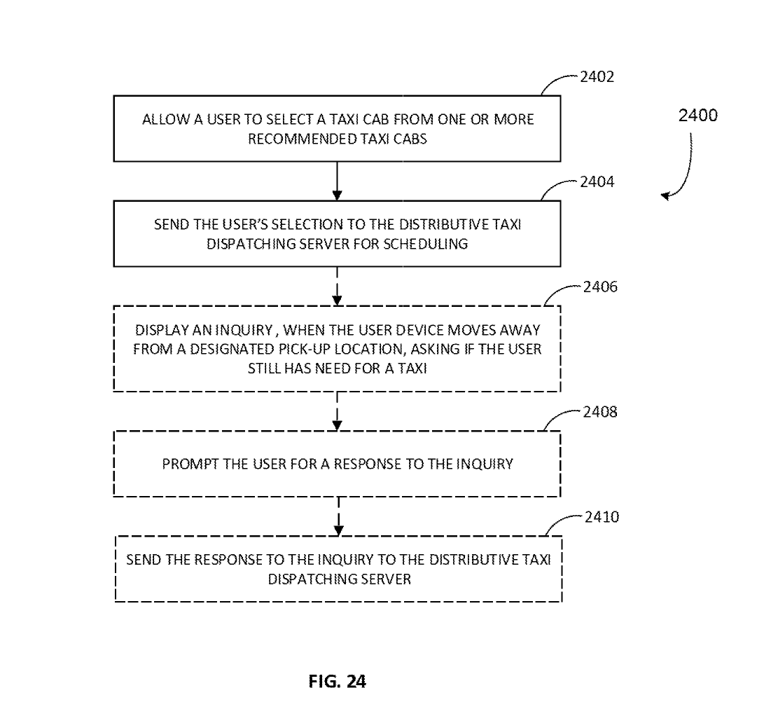

FIG. 24 is an example process flow 2400 of scheduling and monitoring a passenger pick-up by a distributive taxi dispatching service, from the perspective of a user device of a user registered with the distributive taxi dispatching service, according to an embodiment. Once a user requests taxi service and has viewed a displayed list of recommended taxi cabs, at 2402, the user may be allowed to select a taxi cab from the one or more recommended taxi cabs, indicating the taxi cab that the user wishes to schedule. At 2404, the user's selection of a taxi cab is sent to a distributive taxi dispatching server for scheduling. Optionally, the pick-up of the user ma be monitored. For example, the location of the user may be monitored by the user device, the distributive taxi dispatching server, or both, by monitoring the location of the user device. If it is determined (e.g., by the user device or the distributive taxi dispatching server) that the user device has moved away from a designated pick-up location (e.g., by more than a threshold distance), at 2406, an inquiry may be displayed asking if the user still has a need for the requested taxi. At 2408, the user may be prompted for a response to the inquiry, and at 2410, the response to the inquiry may be provided to the distributive taxi dispatching server (e.g., to inform the distributive taxi dispatching server whether the scheduled taxi needs to be rescheduled or cancelled).

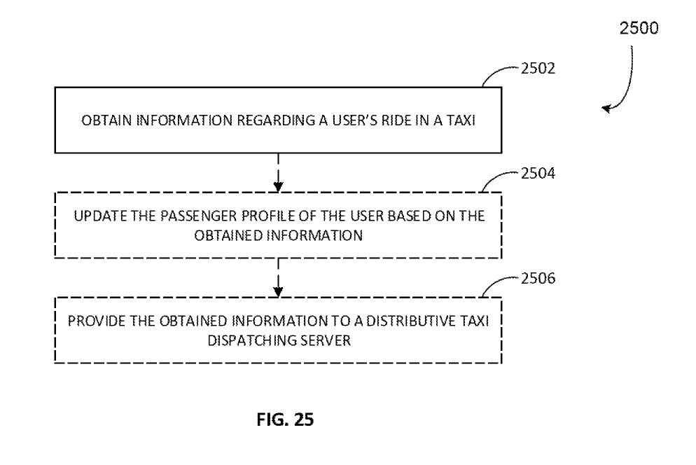

FIG. 25 is an example process flow 2500 of managing feedback regarding a taxi ride by a user device of a user registered with a distributive taxi dispatching service, from the perspective of the user device, according to an embodiment. At 2502, information may be obtained regarding the user's ride in a taxi cab registered with the distributive taxi dispatching service. In an embodiment, the user device may automatically obtain ride feedback by monitoring the user's ride in the registered taxi cab. For example, monitoring may include monitoring locations of the taxi cab, a route taken by the taxi cab, a speed of the taxi cab, duration of travel, aggressiveness of the taxi cab, extent of erratic motion of the taxi cab, etc. This monitoring may be done via monitoring the location of the user device, the taxi cab (e.g., a device within the taxi cab), or both. In an embodiment, the user device may additionally, or instead, receive manually input feedback from the user regarding the ride in the taxi cab that the user may input into the user device via a user interface. If a passenger profile for the user is maintained by the user device, at 2504, the passenger profile may be updated based on the obtained information regarding the user's ride. At 2506, the obtained information regarding the user's ride may be provided to a distributive taxi dispatching server (e.g., to update the passenger profile, if one is maintained at the distributive taxi dispatching server, and/or to update historical data regarding the user and/or the taxi cab).

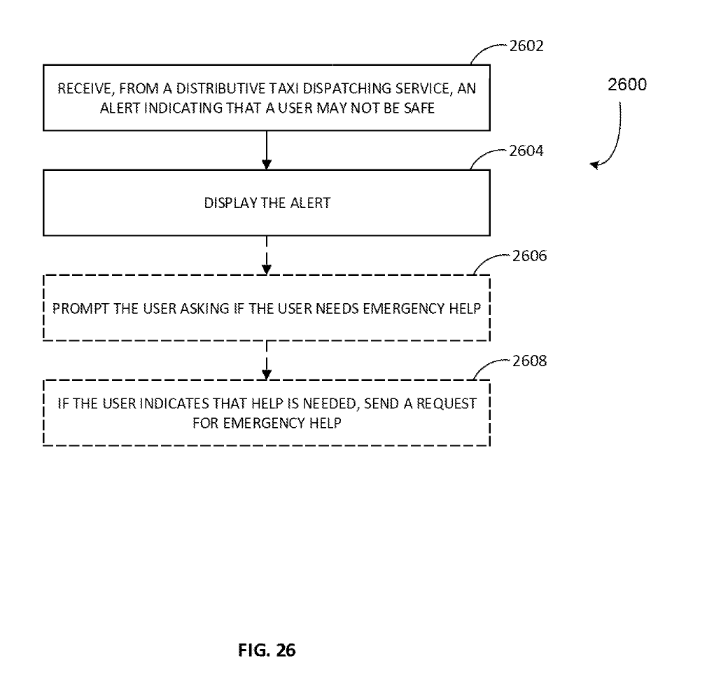

FIG. 26 is an example process flow 2600 of monitoring a taxi ride by a distributive taxi dispatching service, from the perspective of a user device of a user registered with the distributive taxi dispatching service, according to an embodiment. In this embodiment, the user device may receive a safety alert from a distributive taxi dispatching server that may he monitoring the user's ride in the taxi. At 2602, an alert is received from the distributive taxi dispatching server indicating, that the user may not be safe. At 2604, the alert may be displayed or otherwise provided to the user, via text message, email, phone call, etc.) In an embodiment, at 2606, an inquiry may be displayed asking the user if the user needs emergency help. At 2608, if the user indicates that help is needed, a request for emergency help may be sent (e.g., to the distributive taxi dispatching server, or directly to authorities).

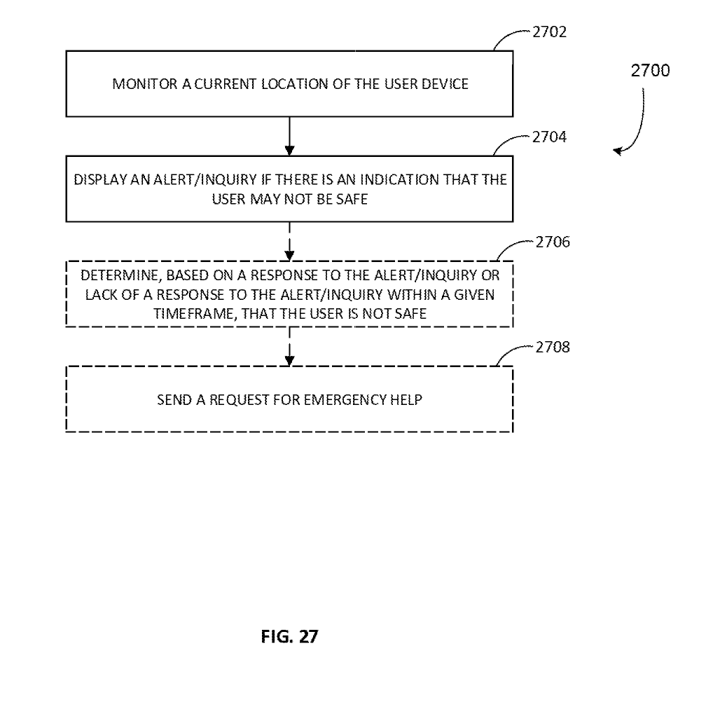

FIG. 27 is an example process flow 2700 of monitoring a taxi ride by a distributive taxi dispatching service, from the perspective of a user device of a user registered with a distributive taxi dispatching service, according to an embodiment. In this embodiment, the user device may monitor safety aspects of the taxi ride. At 2702, a current location of a user in a registered taxi cab may be monitored. This monitoring may be done by monitoring the location of the user device, the taxi cab (e.g., via a device within the taxi cab, receiving updates from a taxi cab service, etc.), or both. The user device may determine, based on the location information, that the user may not be safe, in which case, at 2704, an alert may be displayed or otherwise provided to the user (e.g., via text message, email, phone call, etc.). For example, the user device may determine that there is an indication of, for example, speeding beyond a given speed threshold, erratic driving, deviation from an expected route beyond a given deviation threshold, location in a designated unsafe zone, etc. The displayed alert may include an inquiry asking if the user is in need of emergency help. Optionally, if an inquiry is displayed, at 2706, based on a response to the inquiry or a lack of a response to the inquiry within a given timeframe or time threshold, the user device may determine that the user is indeed not safe. At 2708, the user device may send a request for help. In an example, the user device may alert authorities with the nature of the emergency, the location, and/or the identification of the taxi cab, the user, or both. In another example, the user device may send a request for help to the distributive taxi dispatching server.

There are many additional useful features that may be incorporated into a distributive taxi dispatching service such as the service described herein. For example, in an embodiment, a user may be allowed to create multiple passenger profiles for differing circumstances or situations. For example, a user may wish to maintain certain preferences or thresholds when traveling alone or with another adult, but wish to maintain different preferences or thresholds when traveling with the user's children. In a related example, the user may wish to maintain certain preferences or thresholds when visiting certain cities or countries, but different preferences or thresholds when visiting other cities or countries. Many other circumstances or situations may also be contemplated where a user may wish to have differing passenger profiles.

In an embodiment, taxi recommendations or ratings provided to a user may not only be based on the user's preferences, but also those of users that are “like” them. In this way, the service may be adaptive and may generate recommendations or ratings based on crowd sourcing of user data.

As would be understood by those skilled in the art, although one user device is used in the above descriptions, a user may likely have, and may use, multiple user devices to use the distributive taxi dispatching service. For example, a user may schedule a taxi using the service from the user's home computer, while the user's taxi ride may be monitored in conjunction with a mobile device of the user, such as the user's mobile phone.

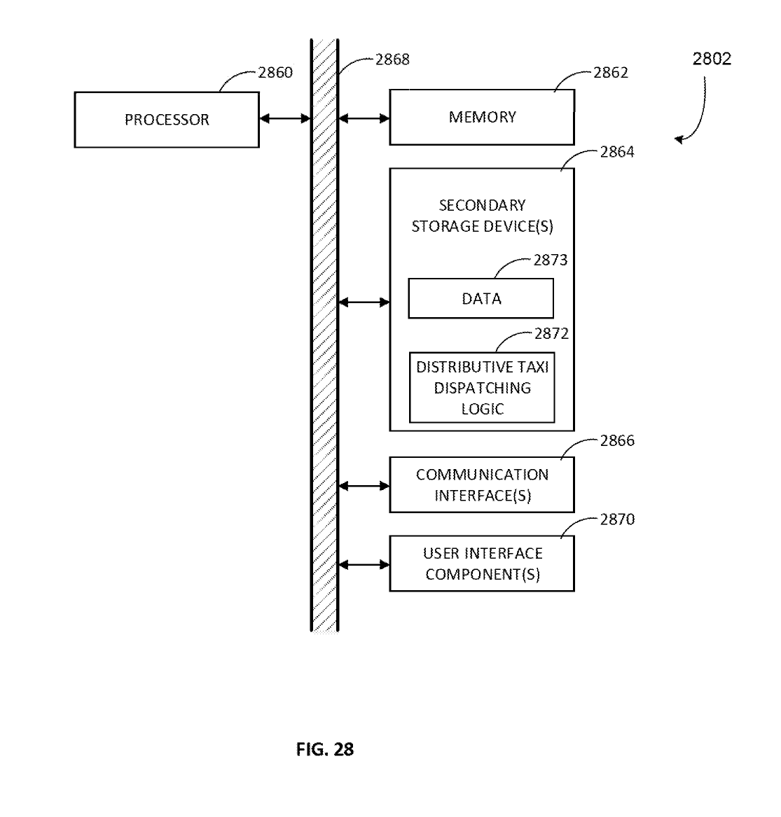

FIG. 28 is a block diagram of an example distributive taxi dispatching server 2802, according to an embodiment. The distributive taxi dispatching server 2802 may represent, for example, the distributive taxi dispatching servers 102, 202, 302, 402, 502, 602, 702, 802, and 902 of FIGS. 1-9, respectively. As illustrated, distributive taxi dispatching server 2802 may include a processor or controller 2860 connected to memory 2862, one or more secondary storage devices 2864, and a communication interface 2866 by a link 2868 or similar mechanism. The distributive taxi dispatching server 2802 may optionally include user interface components 2870 for use by a system or service administrator, for example, that may include, for example, a touchscreen, a display, one or more user input components (e.g., a keyboard, a mouse, etc.), a speaker, or the like, or any combination thereof Note, however, that while not shown, distributive taxi dispatching server 2802 may include additional components. The processor 2860 may be a microprocessor, digital ASIC, FPGA, or similar hardware device. In an embodiment, the processor 2860 may be a microprocessor, and software may be stored or loaded into the memory 2862 for execution by the processor 2860 to provide the functions described herein. The one or more secondary storage devices 2864 may be, for example, one or more hard drives or the like, and may store logic 2872 to be executed by the processor 2860. The one or more secondary storage devices 2864 may also store data 2873. Data 2873 may include, for example, historical data for each registered taxi cab and/or taxi service, one or more passenger profiles, environmental data, safety data, etc. The communication interface 2866 may be implemented in hardware or a combination of hardware and software. The communication interface 2866 may provide a wired or wireless network interface to a network, such as the network 110 shown in FIG. 1.

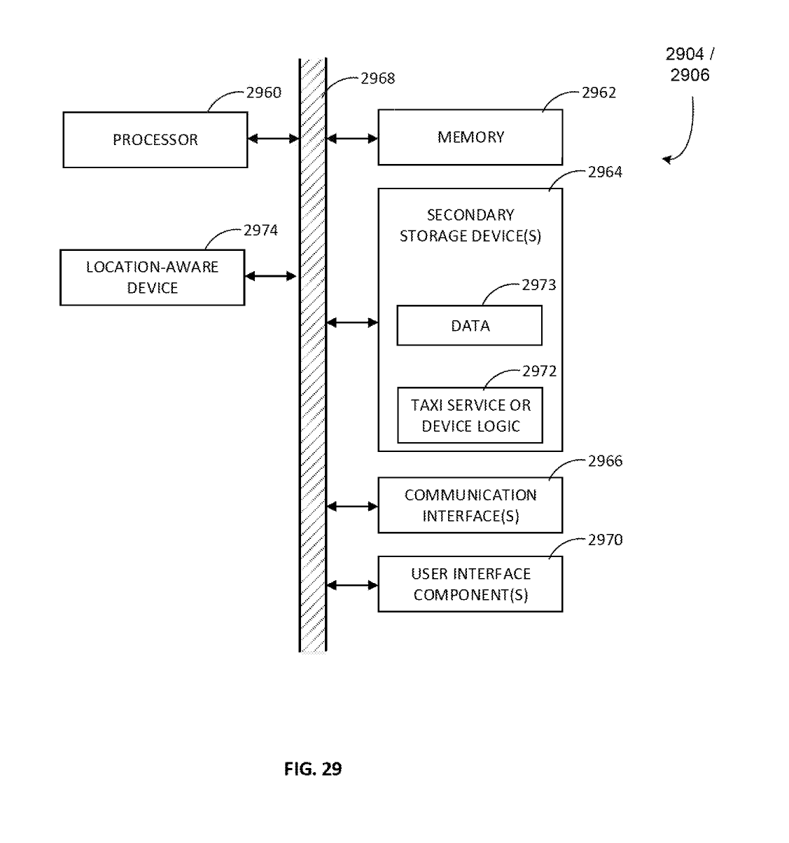

FIG. 29 is a block diagram of an example taxi service server 2904 or taxi cab device 2906, according to an embodiment. The taxi service server/taxi cab device 2904/2906 may represent, for example, the taxi service servers or taxi cab devices shown in FIGS. 1-9. As illustrated, taxi service server/taxi cab device 2904/2906 may include a processor or controller 2960 connected to memory 2962, one or more secondary storage devices 2964, and a communication interface 2966 by a link 2968 or similar mechanism. The taxi service server 1 taxi cab device 2904/2906 may also include user interface components 2970 for use by a user of the taxi service server/taxi cab device 2904/2906 (e.g., a taxi cab service dispatcher or taxi cab driver), that may include, for example, a touchscreen, a display, one or more user input components (e.g., a keyboard, a mouse, etc.), a speaker, or the like, or any combination thereof. Taxi service server/taxi cab device 2904/2906 may also include a location-aware device 2974, such as a global positioning system (GPS) device. Note, however, that while not shown, taxi service server taxi cab device 2904/2906 may include additional components. The processor 2960 may be a microprocessor, digital ASIC. FPGA, or similar hardware device. In an embodiment, the processor 2960 may be a microprocessor, and software may be stored or loaded into the memory 2962 for execution by the processor 2960 to provide the functions described herein. The one or more secondary storage devices 2964 may be, for example, one or more hard. drives or the like, and may store logic 2972 to be executed by the processor 2960. The one or more secondary storage devices 2964 may also store data 2973. Data 2973 may include, for example, fare information, route information, etc. The communication interface 2966 may be implemented in hardware or a combination of hardware and software. The communication interface 2966 may provide a wired or wireless network interface to a network, such as the network 110 shown in FIG. 1.

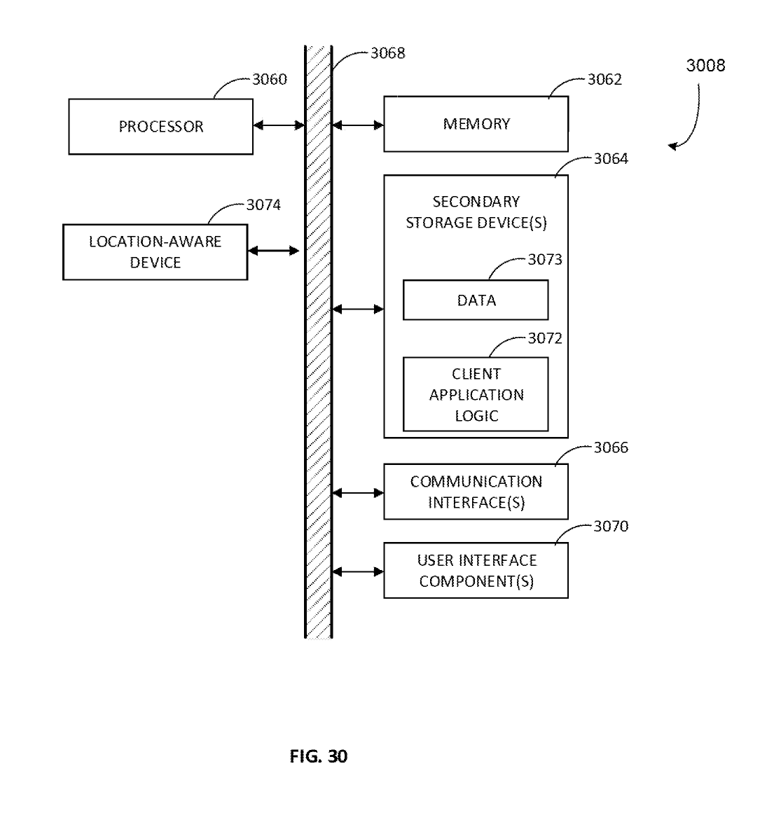

FIG. 30 is a block diagram of an example user device 3008, according to an embodiment. The user device 3008 may represent, for example, the user devices 108, 208, 308, 408, 508, 608, 708, 808, and 908 of FIGS. 1-9, respectively. As illustrated, user device 3008 may include a processor or controller 3060 connected to memory 3062, one or more secondary storage devices 3064, and a communication interface 3066 by a link 3068 or similar mechanism. The user device 3008 may also include user interface components 3070 for use by a user of the user device (e.g., a passenger), that may include, for example, a touchscreen, a display, one or more user input components (e.g., a keyboard, a mouse, etc.), a speaker, or the like, or any combination thereof User device 3008 may also include a location-aware device 3074, such as a global positioning system (GPS) device. Note, however, that while not shown, user device 3008 may include additional components. The processor 3060 may be a microprocessor, digital ASIC. FPGA, or similar hardware device. In an embodiment, the processor 3060 may be a microprocessor, and software may be stored or loaded into the memory 3062 for execution by the processor 3060 to provide the functions described herein. The one or more secondary storage devices 3064 may be, for example, one or more hard drives or the like, and may store logic 3072 to be executed by the processor 3060. The one or more secondary storage devices 3064 may also store data 3073. Data 3073 may include, for example, one or more passenger profiles. The communication interface 3066 may be implemented in hardware or a combination of hardware and software. The communication interface 3066 may provide a wired or wireless network interface to a network, such as the network 110 shown in FIG. 1.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

As discussed above, one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The terms software and firmware, as used herein, refer to a computer program product including at least one computer readable medium having computer program logic, such as computer-executable instructions, stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, SRAM, DRAM, a hard drive, a solid state drive, or other data storage device.

Technologies disclosed herein provide taxi services to travelers that facilitate convenient, comfortable, efficient, cost-effective, and safe taxi ride experiences. With the technologies disclosed herein, the described cloud-based taxi service may allow a user of the service to use a personal computing device to request and use taxi service by leveraging one or more of the traveler's location and preferences, along with one or more of the location, pricing, availability, and historical review data of one or more taxi service companies or cabs. By using this service, a real-time match between the traveler and a cab may be coordinated to provide the traveler with a comfortable, cost-effective, and safe ride to the traveler's desired destination. The service is distributive in nature, as it may distribute a large pool of passengers across many taxi service providers, allowing for greater competition and transparency on fares and quality of service. Subscribing to this service, the taxi service providers may bid on fares based on their taxi cabs’ current availability, location, service status, schedules, etc., providing a user with choices based on time to pick-up, fares, and their personal preferences.

The particular examples and scenarios used in this document are for ease of understanding and are not to be limiting. Features described herein may be used in many other contexts and situations that may or may not involve taxis or even vehicular travel directly. For example, in addition to taxi services, technologies described herein may apply to other types of transportation services or vehicles, which may be motorized (e.g., limousine services, bus services, van services, boat services, ferry services, train services, flight services, etc.) or non-motorized (e.g., carriage services, bicycle services, rickshaw services, etc.). Technologies described herein may also apply to driverless and/or computer-guided land- or air-based conveyance. Technologies described herein may also apply to tour services (bus tours, boat tours, ATV tours, snowmobile tours, Segway tours, horse or other animal) tours, etc.), or even vehicles used for personal use (e.g., rental cars, boats, jet skis, snowmobiles, horses (or other animals), etc.). In addition, the safety related features described herein may be useful in any of the above contexts, or even in non-vehicular contexts (e.g., walking, jogging, hiking, swimming, skiing, etc.). Many other contexts and uses may also be contemplated.

There are many advantages of using the technologies described herein. One advantage of the service is that it may provide more efficient taxi cab dispatching. Additionally, having a greater pool of prospective passengers may increase the opportunity align fares, minimize downtime, and decrease wait time and/or cost for the passengers. If a user provides a destination address when requesting a taxi, this may further help to optimize prediction routines, position empty taxis, etc. The destination information may also be used to provide more accurate estimated fares to the passenger, and possibly an agreed-upon fare prior to travel.

Another advantage is that much of the data incorporated into ratings and recommendations is data that is not subjective, but instead based on actual behavior of passengers and taxi cabs/services, which may' e collected automatically by the distributive taxi dispatching service. This objective data may help to validate subjective passenger feedback. In this way, ratings and recommendations are not based solely on entered (i.e., subjective) input, which may be biased and/or not necessarily indicative of the whole truth. This real-time automated collection of behavior makes the system dynamic in nature and provides a service that is constantly and dynamically improving. For example, an actual route taken may be compared by the service to a known optimal route with consideration given for traffic updates and route alternatives (e.g., shortest distances versus fastest time and/or accident avoidance). The information collected during the ride may be stored for future comparisons, and ultimately, improved future route recommendations. Similarly, since the travel duration and route taken by a taxi driver is known by the system without user input, this information may be used to provide rating information specifically with regard to drivers.

A further advantage is that the ratings and/or recommendations take a user's own preferences into account. In other words, the ratings and/or recommendations are customized for each user. For the same taxi cab or service, the ratings and/or recommendations for two different users may be determined to be quite different depending on the known preferences of the two users.

Yet another advantage is that the historical data collected regarding taxi travel, in conjunction with online payment capabilities which may provide a record of actual fares, may provide a level of security and honesty with regard to taxi travel. For example, it adds to the value of the automated recommendations and ratings, as it provides accurate information with regard to route/time versus price. It may also ensure a fair negotiation of agreed upon rates and/or routes, as well as a fair exchange rate when traveling internationally. In addition, if there is ever an issue among passengers, drivers, taxi service companies, etc., there is unbiased historical data available for dispute resolution, etc.

Many other advantages may also be contemplated.

As used in this application and in the claims, a list of items joined by the term “one or more of” can mean any combination of the listed terms. For example, the phrases “one or more of A, B or C” and “one or more of A, B, and can mean A; B; C; A and B; A and C; B and C; or A, B and C.

The following examples pertain to further embodiments.

### Server Examples

Example 1 may include a distributive taxi dispatching server associated with distributive taxi dispatching service, comprising: one or more data stores having stored therein one or more of registration data relating to users and taxi cabs registered with the distributive taxi dispatching service, historical data relating to the registered taxi cabs, or passenger profiles of the registered users; a processor; a communication system in communication with the processor and a network; and a memory in communication with the processor, the memory having stored therein a plurality of processing instructions adapted to direct the processor to: receive, from a user device of a registered user, a request for taxi information; obtain the requested taxi information from one or more computing devices of one or more taxi cabs or taxi service companies and from the one or more data stores; and provide the requested taxi information to the user device.

Example 2 may include the subject matter of Example 1, wherein receiving the request for taxi information includes receiving a photo of an identifier on a taxi cab; obtaining the requested taxi information includes verifying that the taxi cab identified by the identifier is registered with the distributive taxi dispatching service; and providing the requested taxi information to the user device includes providing, to the user device, the results of the verification that the taxi cab is registered with the distributive taxi dispatching service.

Example 3 may include the subject matter of Example 2, wherein: obtaining the requested taxi information further includes obtaining one or more of pricing or rating information for the taxi cab; and providing the requested taxi information further includes providing one or more of the pricing or the rating information for the taxi cab.

Example 4 may include the subject matter of Example 1, wherein: receiving the request for taxi information includes receiving a pick-up location designation from the user device, receiving a destination designation from the user device, and obtaining a passenger profile of the user; obtaining the requested taxi information includes obtaining availability information, pricing information, and location information regarding registered taxi cabs; and providing the requested taxi information to the user device includes determining one or more recommended taxi cabs based on user preferences and the obtained availability information, pricing information, and location information of registered taxi cabs, and providing information regarding the one or more recommended taxi cabs to the user device.

Example 5 may include the subject matter of Example 4, wherein the obtaining the passenger profile of the user includes obtaining the passenger profile of the user from the one or more data stores.

Example 6 may include the subject matter of Example 4, wherein the obtaining the passenger profile of the user includes requesting and receiving the passenger profile from the user device.

Example 7 may include the subject matter of any of Examples 4-6, wherein the determining the one or more recommended taxi cabs is further based on historical data of registered taxi cabs.

Example 8 may include the subject matter of any of Examples 4-7, wherein the determining the one or more recommended taxi cabs is further based on current conditions at a first location represented by the location designation and a second location represented by the destination designation.

Example 9 may include the subject matter of any of Examples 4-8, wherein the providing information regarding the one or more recommended taxi cabs to the user device includes providing to the user device, for each of the one or more recommended taxi cabs, a cab identifier and one or more of an estimated time of arrival, a recommended route, an estimated fare, and a rating.

Example 10 may include the subject matter of Example 9, wherein the pick-up location designation is a location designation previously received by the user device via input by the user.

Example 11 may include the subject matter of any of Examples 4-10, wherein the plurality of processing instructions is further adapted to direct the processor to: receive a requested pick-up time from the user device; receive a taxi cab selection from the user device; and schedule the requested pick-up time with a taxi cab associated with the taxi cab selection.

Example 12 may include the subject matter of Example 11, wherein the plurality of processing instructions is further adapted to direct the processor to: monitor a current location of the user; determine, based on the requested pick-up time and current location of the user, an estimated time of arrival of the user at the pick-up location; and if the difference between the estimated time of arrival and the requested pick-up time is greater than a given lateness threshold, re-schedule a new pick-up time with the taxi cab.

Example 13 ma include the subject matter of any of Examples 4-9, wherein the pick-up location designation is an automatically determined current location of the user device.

Example 14 may include the subject matter of any of Examples 4-13, wherein the plurality of processing instructions is further adapted to direct the processor to: receive a request to schedule a ride with a chosen one of the one or more recommended taxi cabs; schedule the ride with the chosen taxi cab; monitor a current location of the user device; determine, based on the current location, that the user has moved away from a location represented by the pick-up location designation; send an inquiry to the user device asking if the user still has need for a taxi; receive a response to the inquiry; if the response to the inquiry confirms that the user still has a need for a taxi, update the scheduling for the taxi with a new pick-up location designation; and if the response to the inquiry confirms that the user no longer needs a taxi, cancel the scheduling of the chosen taxi cab.

Example 15 may include the subject matter of Example 1, wherein the plurality of processing instructions is further adapted to direct the processor to: determine a current location of the user device; determine current conditions at the current location; and send an inquiry to the user device asking if the user would like to take a taxi.

Example 16 may include the subject matter of any of Examples 1-15, wherein the plurality of processing instructions is further adapted to direct the processor to receive confirmation that the user is inside a registered taxi cab. Example 17 may include the subject matter of Example 16, wherein the plurality of processing instructions is further adapted to direct the processor to obtain information regarding the user's ride in the taxi cab.

Example 18 may include the subject matter of Example 17, wherein the obtaining of information regarding the user's ride includes obtaining route and duration of travel information by monitoring the current location of the user device from a pick-up location to a destination location.

Example 19 may include the subject matter of Example 17 or Example 18, wherein the obtaining of information regarding the user's ride includes receiving user-entered feedback regarding the ride from the user device.

Example 20 may include the subject matter of any of Examples 17-19, wherein historical data regarding the taxi cab is updated based on the obtained information regarding the user's ride in the taxi cab.

Example 21 may include the subject matter of any of Examples 17-20, wherein a passenger profile of the user is updated based on the obtained information regarding the user's ride in the taxi cab.

Example 22 may include the subject matter of any of Examples 16-21, wherein the plurality of processing instructions is further adapted to direct the processor to: monitor a current location of the user device; and provide an alert to the user device if there is an indication that the user may not be safe.

Example 23 may include the subject matter of Example 22, wherein the plurality of processing instructions is further adapted to direct the processor to: determine, based on a response to the alert from the user device or lack of a response to the alert from the user device within a given timeframe that the user is not safe; and alert authorities with a location and identification of the taxi cab, user, or both.

Example 24 may include the subject matter of Example 22 or Example 23, wherein the indication that the user may not be safe includes indication of one or more of speeding beyond a given speed threshold, erratic driving, deviation from an expected route beyond a given deviation threshold, or location in a designated unsafe zone.

Example 25 may include the subject matter of any of Examples 16-24, wherein the plurality of processing instructions is further adapted to direct the processor to: receive payment information from the user device; and provide the payment information to the appropriate taxi cab or taxi service company.

Example 26 may include an apparatus associated with a distributive taxi dispatching service, comprising: means for receiving, from a user device of a user registered with the distributive taxi dispatching service, a request for taxi information; means for obtaining the requested taxi information from one or more computing devices of one or more taxi cabs or taxi service companies and from one or more data stores, the data stores having stored therein one or more of registration data relating to users and taxi cabs registered with the distributive taxi dispatching service, historical data relating to the registered taxi cabs, or passenger profiles of the registered users; and means for providing the requested taxi information to the user device.

Example 27 may include the subject matter of Example 26, wherein: the means for receiving the request for taxi information includes means for receiving a photo of an identifier on a taxi cab; the means for obtaining the requested taxi information includes means for verifying that the taxi cab identified by the identifier is registered with the distributive taxi dispatching service; and the means for providing the requested taxi information to the user device includes means for providing, to the user device, the results of the verification that the taxi cab is registered with the distributive taxi dispatching service,

Example 28 may include the subject matter of Example 26, wherein: the means for receiving the request for taxi information includes means for receiving a pick-up location designation from the user device, means for receiving a destination designation from the user device, and means for obtaining a passenger profile of the user; the means for obtaining the requested taxi information includes means for obtaining availability information, pricing information, and location information regarding registered taxi cabs, and the means for providing the requested taxi information to the user device includes means for determining one or more recommended taxi cabs based on user preferences and the obtained availability information, pricing information, and location information of registered taxi cabs, and means for providing information regarding the one or more recommended taxi cabs to the user device.

Example 29 may include a computer-readable medium storing control logic configured to instruct a processor of a computing device to: receive, from a user device of a user registered with the distributive taxi dispatching service, a request for taxi information; obtain the requested taxi information from one or more computing devices of one or more taxi cabs or taxi service companies and from one or more data stores, the data stores having stored therein one or more of registration data relating to users and taxi cabs registered with the distributive taxi dispatching service, historical data relating to the registered taxi cabs, or passenger profiles of the registered users; and provide the requested taxi information to the user device.

Example 30 may include the subject matter of Example 29, wherein: receiving the request for taxi information includes receiving a photo of an identifier on a taxi cab; obtaining the requested taxi information includes verifying that the taxi cab identified by the identifier is registered with the distributive taxi dispatching service; and providing the requested taxi information to the user device includes providing, to the user device, the results of the verification that the taxi cab is registered with the distributive taxi dispatching service.

Example 31 may include the subject matter of Example 29, wherein: receiving the request for taxi information includes receiving a pick-up location designation from the user device, receiving a destination designation from the user device, and obtaining a passenger profile of the user; obtaining the requested taxi information includes obtaining availability information, pricing information, and location information regarding registered taxi cabs; and providing the requested taxi information to the user device includes determining one or more recommended taxi cabs based on user preferences and the obtained availability information, pricing information, and location information of registered taxi cabs, and providing information regarding the one or more recommended taxi cabs to the user device.

Example 32 may include a method of providing a distributive taxi dispatching service, comprising: receiving, from a user device of a user registered with the distributive taxi dispatching service, a request for taxi information; obtaining the requested taxi information from one or more computing devices of one or more taxi cabs or taxi service companies and from one or more data stores, the data stores having stored therein one or more of registration data relating to users and taxi cabs registered with the distributive taxi dispatching service, historical data relating to the registered taxi cabs, or passenger profiles of the registered users; and providing the requested taxi information to the user device.

Example 33 may include the subject matter of Example 32, wherein: receiving the request for taxi information includes receiving a photo of an identifier on a taxi cab; obtaining the requested taxi information includes verifying that the taxi cab identified by the identifier is registered with the distributive taxi dispatching service; and providing the requested taxi information to the user device includes providing, to the user device, the results of the verification that the taxi cab is registered with the distributive taxi dispatching service.

Example 34 may include the subject matter of Example 33, wherein: obtaining the requested taxi information further includes obtaining one or more of pricing or rating information for the taxi cab; and providing the requested taxi information further includes providing one or more of the pricing or the rating information for the taxi cab.

Example 35 may include the subject matter of Example 32, wherein: receiving the request for taxi information includes receiving a pick-up location designation from the user device, receiving a destination designation from the user device, and obtaining a passenger profile of the user; obtaining the requested taxi information includes obtaining availability information, pricing information, and location information regarding registered taxi cabs; and providing the requested taxi information to the user device includes determining one or more recommended taxi cabs based on user preferences and the obtained availability information, pricing information, and location information of registered taxi cabs, and providing information regarding the one or more recommended taxi cabs to the user device.

Example 36 may include the subject matter of Example 35, wherein the obtaining the passenger profile of the user includes obtaining the passenger profile of the user from the one or more data stores.

Example 37 may include the subject matter of Example 35, wherein the obtaining the passenger profile of the user includes requesting and receiving the passenger profile from the user device.

Example 38 may include the subject matter of any of Examples 35-37, wherein the determining the one or more recommended taxi cabs is further based on historical data of registered taxi cabs.

Example 39 may include the subject matter of any of Examples 35-38, wherein the determining the one or inure recommended taxi cabs is further based on current conditions at a first location represented by the location designation and a second location represented by the destination designation.

Example 40 may include the subject matter of any of Examples 35-39, wherein the providing information regarding the one or more recommended taxi cabs to the user device includes providing to the user device, for each of the one or more recommended taxi cabs, a cab identifier and one or more of an estimated time of arrival, a recommended route, an estimated fare, and a rating.

Example 41 may include the subject matter of Example 40, wherein the pick-up location designation is a location designation previously received by the user device via input by the user.

In Example 42, any of Examples 35-41 may optionally include receiving a requested pick-up time from the user device; receiving a taxi cab selection from the user device; and scheduling the requested pick-up time with a taxi cab associated with the taxi cab selection.

In Example 43, Example 42 may optionally include monitoring a current location of the user; determining, based on the requested pick-up time and current location of the user, an estimated time of arrival of the user at the pick-up location; and if the difference between the estimated time of arrival and the requested pick-up time is greater than a given lateness threshold, re-scheduling a new pick-up time with the taxi cab.

Example 44 may include the subject matter of Example 35, wherein the pick-up location designation is an automatically determined current location of the user device.

In Example 45, any of Examples 35-44 may optionally include receiving a request to schedule a ride with a chosen one of the one or more recommended taxi cabs; scheduling the ride with the chosen taxi cab; monitoring a current location of the user device; determining, based on the current location, that the user has moved away from a location represented by the pick-up location designation; sending an inquiry to the user device asking if the user still has need for a taxi; receiving a response to the inquiry; if the response to the inquiry confirms that the user still has a need for a taxi, updating the scheduling for the taxi with a new pick-up location designation; and if the response to the inquiry confirms that the user no longer needs a taxi, cancelling the scheduling of the chosen taxi cab,

In Example 46, Example 32 may optionally include determining a current location of the user device; determining current conditions at the current location; and sending an inquiry to the user device asking if the user would like to take a taxi.

In Example 47, any of Examples 32-46 may optionally include receiving confirmation that the user is inside a taxi cab registered with the distributive taxi dispatching service,

In Example 48, Example 47 may optionally include obtaining information regarding the user's ride in the taxi cab.

Example 49 may include the subject matter of Example 48, wherein the obtaining of information regarding the user's ride includes obtaining route and duration of travel information by monitoring the current location of the user device from a pick-up location to a destination location.

Example 50 may include the subject matter of Example 48 or Example 49, wherein the obtaining of information regarding the user's ride includes receiving user-entered feedback regarding the ride from the user device.

Example 51 may include the subject matter of any of Examples 48-50, wherein historical data regarding the taxi cab is updated based on the obtained information regarding the user's ride in the taxi cab.

Example 52 may include the subject matter of any of Examples 48-51, wherein a: passenger profile of the user is updated based on the obtained information regarding the user's ride in the taxi cab.

In Example 53, any of Examples 47-52 may optionally include monitoring a current location of the user device; and providing an alert to the user device if there is an indication that the user may not be safe.

In Example 54, Example 53 may optionally include determining, based on a response to the alert or lack of a response to the alert within a given timeframe, that the user is not safe; and alerting authorities with a location and identification of the taxi cab, user or both.

Example 55 may include the subject matter of Example 53 or Example 54, wherein the indication that the user may not be safe includes indication of one or more of speeding beyond a given speed threshold, erratic driving, deviation from an expected route beyond a given deviation threshold, or location in a designated unsafe zone.

In Example 56, any of Examples 47-55 may optionally include receiving payment information from the user device; and providing the payment information to the appropriate taxi cab or taxi service company.

Example 57 may include at least one machine readable medium comprising a plurality of instructions that in response to being executed on a computing device, cause the computing device to carry out a method according to any one of Examples 32-56.

Example 58 may include an apparatus configured to perform the method of any one of Examples 32-56.

Example 59 may include a computer system to perform the method of any of Examples 32-56.

Example 60 may include a machine to perform the method of any of Examples 32-56.

Example 61 may include an apparatus comprising means for performing the Method of any one of Examples 32-56.

Example 62 may include a computing device comprising memory and a chipset configured to perform the method of any one of Examples 32-56.

### User Device Examples

Example 1 may include a computing device of a user registered with a distributive taxi dispatching service, comprising: a processor; a user interface in communication with the processor; a communication system in communication with the processor and a network; and a memory in communication with the processor, the memory having stored therein a plurality of processing instructions adapted to direct the processor to: send a request for taxi information to a distributive taxi dispatching server; receive the requested taxi information from the distributive taxi dispatching server; and display the requested taxi information via the user interface.

Example 2 may include the subject matter of Example 1, wherein the plurality of processing instructions are further adapted to direct the processor to: receive a near-field Wi-Fi signal from a nearby taxi cab confirming that the taxi cab is registered with the distributive taxi dispatching service; and display the confirmation that the taxi cab is registered with the distributive taxi dispatching service.

Example 3 may include the subject matter of Example 2, wherein the request for taxi information includes a request for taxi information regarding the nearby taxi cab.

Example 4 may include the subject matter of Example 3, wherein the received taxi information includes a rating of the nearby taxi cab.

Example 5 may include the subject matter of Example 1, wherein the request for taxi information includes a photo of an identifier of a nearby taxi cab; and wherein the received requested taxi information includes a confirmation that the taxi cab is registered with the distributive taxi dispatching service.

Example 6 may include the subject matter of Example 1, wherein the request for taxi information includes a request for a taxi registered with the distributive taxi dispatching service, wherein the request includes a pick-up location designation and a destination location designation.

Example 7 may include the subject matter of Example 6, wherein the pick-up location designation is an automatically determined location designation designating a current location of the computing device.

Example 8 may include the subject matter of Example 6, wherein the plurality of processing instructions are further adapted to direct the processor to: prompt the user to input the pick-up location designation and the destination designation; and receive input from the user designating the pick-up location designation and the destination location designation.

Example 9 may include the subject matter of any of Examples 6-8, wherein the plurality of processing instructions are further adapted to direct the processor to determine one or more recommended taxi cabs registered with the distributive taxi dispatching service based on the received taxi information, wherein the displaying the requested taxi information includes displaying a list of the one or more recommended taxi cabs.

Example 10 may include the subject matter of any of Examples 6-8, wherein the received taxi information includes information regarding one or more recommended taxi cabs registered with the distributive taxi dispatching service.

Example 11 may include the subject matter of Example 10, wherein the information regarding the one or more recommended taxi cabs includes, for each of the one or more recommended taxi cabs, a cab identifier and one or more of an estimated time of arrival, a recommended route, an estimated fare, and a rating.

Example 12 may include the subject matter of Example 10 or Example 11, wherein the plurality of processing instructions are further adapted to direct the processor to: allow the user to select a taxi cab of the one or more recommended taxi cabs; and send the user's selection of the taxi cab to the distributive taxi dispatching server.

Example 13 may include the subject matter of Example 12, wherein the plurality of processing instructions are further adapted to direct the processor to: display an inquiry, when the computing device moves away from the location designated by the pick-up location designation, asking if the user still has need for a taxi; prompt the user for a response to the inquiry; and send the response to the inquiry to the distributive taxi dispatching server.

Example 14 may include the subject matter of any of Examples 6-13, wherein the request for taxi information further includes a passenger profile of the user.

Example 15 may include the subject matter of Example 14, wherein the received taxi information includes information regarding one or more recommended taxi cabs registered with the distributive taxi dispatching service that takes into account the passenger profile of the user.

Example 16 may include the subject matter of Example 14 or Example 15, wherein the plurality of processing instructions are further adapted to direct the processor to allow the user to edit the passenger profile via the user interface.

Example 17 may include the subject matter of any of Examples 1-13, wherein the received taxi information includes information regarding one or more taxi cabs registered with the distributive taxi dispatching service that takes into account a passenger profile of the user.

Example 18 may include the subject matter of Example 1, wherein the plurality of processing instructions are further adapted to direct the processor to display an inquiry asking if the user would like to take a taxi due to current conditions at a current location of the computing device.

Example 19 may include the subject matter of any of Examples 1-18, wherein the plurality of processing instructions are further adapted to direct the processor to obtain confirmation that the user is inside a taxi cab registered with the distributive taxi dispatching service based on the provided taxi information.

Example 20 may include the subject matter of Example 19, wherein the plurality of processing instructions are further adapted to direct the processor to obtain information regarding the user's ride in the taxi cab.

Example 21 may include the subject matter of Example 20, wherein the plurality of processing instructions are further adapted to direct the processor to allow the user to enter feedback regarding the user's ride via the user interface.

Example 22 may include the subject matter of Example 20 or Example 21, wherein the plurality of processing instructions are further adapted to direct the processor to update a passenger profile of the user based on the obtained information regarding the user's ride.

Example 23 may include the subject matter of any of Examples 19-22, wherein the plurality of processing instructions are further adapted to direct the processor to: receive an alert from the distributive taxi dispatching server indicating that the user may not be safe; and display the alert via the user interface.

Example 24 may include the subject matter of Example 23, wherein the plurality of processing instructions are further adapted to direct the processor to: prompt the user as to whether the user needs emergency help; and if the user indicates that help is needed, send a request for emergency help.

Example 25 may include the subject matter of any of Examples 19-22, wherein the plurality of processing instructions are further adapted to direct the processor to: monitor a current location of the computing device; and display an alert if there is an indication that the user may not be safe.

Example 26 may include the subject matter of Example 25, wherein the plurality of processing instructions are further adapted to direct the processor to: determine, based on a response to the alert or lack of a response to the alert within a given timeframe, that the user is not safe; and send a request for emergency help.

Example 27 may include the subject matter of Example 25 or Example 26, wherein the indication that the user may not be safe includes indication of one or more of speeding beyond a given speed threshold, erratic driving, deviation from an expected route beyond a given deviation threshold, or location in a designated unsafe zone.

Example 28 may include the subject matter of any of Examples 19-27, wherein the plurality of processing instructions are further adapted to direct the processor to allow the user to pay for the taxi cab via the user interface.

Example 29 may include an apparatus of a user registered with a distributive taxi dispatching service, comprising: means for sending a request for taxi information to a distributive taxi dispatching server; means for receiving the requested taxi information from the distributive taxi dispatching server; and means for displaying the requested taxi information via a user interface.

In Example 30, Example 29 may optionally include means for receiving a near-field Wi-Fi signal from a nearby taxi cab confirming that the taxi cab is registered with the distributive taxi dispatching service; and means for displaying the confirmation that the taxi cab is registered with the distributive taxi dispatching service.

Example 31 may include the subject matter of Example 30, wherein the request for taxi information includes a request for taxi information regarding the nearby taxi cab.

Example 32 may include the subject matter of Example 31, wherein the received taxi information includes a rating of the nearby taxi cab.

Example 33 may include the subject matter of Example 29, wherein the request for taxi information includes a request for a taxi registered with the distributive taxi dispatching service, wherein the request includes a pick-up location designation and a destination location designation.

In Example 34, Example 33 may optionally include means for prompting the user to input the pick-up location designation and the destination designation; and means for receiving input from the user designating the pick-up location designation and the destination location designation.

In Example 35, Example 34 may optionally include means for determining one or more recommended taxi cabs registered with the distributive taxi dispatching service based on the received taxi information, wherein the means for displaying the requested taxi information includes means for displaying a list of the one or more recommended taxi cabs.

Example 36 may include the subject matter of Example 33 or Example 34, wherein the received taxi information includes information regarding one or more recommended taxi cabs registered with the distributive taxi dispatching service.

In Example 37, Example 36 may optionally include means for allowing the user to select a taxi cab of the one or more recommended taxi cabs; and means for sending the user's selection of the taxi cab to the distributive taxi dispatching server.

Example 38 may include the subject matter of any of Examples 33-37, wherein the request for taxi information further includes a passenger profile of the user.

Example 39 may include the subject matter of Example 38, wherein the received taxi information includes information regarding one or more recommended taxi cabs registered with the distributive taxi dispatching service that takes into account the passenger profile of the user.

Example 40 may include a computer-readable medium storing control logic configured to instruct a processor of a computing device to: send a request for taxi information to a distributive taxi dispatching server; receive the requested taxi information from the distributive taxi dispatching server; and display the requested taxi information via a user interface.

Example 41 may include the subject matter of Example 40, wherein the control logic is configured to further instruct the processor of the computing device to: receive a near-field Wi-Fi signal from a nearby taxi cab confirming that the taxi cab is registered with the distributive taxi dispatching service: and display the confirmation that the taxi cab is registered with the distributive taxi dispatching service.

Example 42 may include the subject matter of Example 41, wherein the request for taxi information includes a request for taxi information regarding the nearby taxi cab.

Example 43 may include the subject matter of Example 42, wherein the received taxi information includes a rating of the nearby taxi cab.

Example 44 may include the subject matter of Example 40, wherein the request for taxi information includes a request for a taxi registered with the distributive taxi dispatching service, wherein the request includes a pick-up location designation and a destination location designation.

Example 45 may include the subject matter of Example 44, wherein the control logic is configured to further instruct the processor of the computing device to: prompt the user to input the pick-up location designation and the destination designation; and receive input from the user designating the pick-up location designation and the destination location designation.

Example 46 may include the subject matter of Example 44 or Example 45, wherein the control logic is configured to further instruct the processor of the computing device to: determine one or more recommended taxi cabs registered with the distributive taxi dispatching service based on the received taxi information, wherein the displaying the requested taxi information includes displaying a list of the one or more recommended taxi cabs.

Example 47 may include the subject matter of Example 44 or Example 45, wherein the received taxi information includes information regarding one or more recommended taxi cabs registered with the distributive taxi dispatching service.

Example 48 may include the subject matter of Example 47, wherein the control logic is configured to further instruct the processor of the computing device to: allow the user to select a taxi cab of the one or more recommended taxi cabs; and send the user's selection of the taxi cab to the distributive taxi dispatching server.

Example 49 may include the subject matter of any of Examples 44-48 wherein the request for taxi information further includes a passenger profile of the user.

Example 50 may include the subject matter of Example 49, wherein the received taxi information includes information regarding one or more recommended taxi cabs registered with the distributive taxi dispatching service that takes into account the passenger profile of the user.

Example 51 may include a method of providing a distributive taxi dispatching service comprising: sending a request for taxi information to a distributive taxi dispatching server; receiving the requested taxi information from the distributive taxi dispatching server; and displaying the requested taxi information via a user interface to a user registered with the distributive taxi dispatching service.

In Example 52, Example 51 may optionally include receiving a near-field signal from a. nearby taxi cab confirming that the taxi cab is registered with the distributive taxi dispatching service; and displaying the confirmation that the taxi cab is registered with the distributive taxi dispatching service.

Example 53 may include the subject matter of Example 52, wherein the request for taxi information includes a request for taxi information regarding the nearby taxi cab.

Example 54 may include the subject matter of Example 53, wherein the received taxi information includes a rating of the nearby taxi cab.

Example 55 may include the subject matter of Example 51, wherein the request for taxi information includes a photo of an identifier of a nearby taxi cab, and wherein the received requested taxi information includes a confirmation that the taxi cab is registered with the distributive taxi dispatching service.

Example 56 may include the subject matter of Example 51, wherein the request for taxi information includes a request for a taxi registered with the distributive taxi dispatching service, wherein the request includes a pick-up location designation and a destination location designation.

Example 57 may include the subject matter of Example 56, wherein the pick-up location designation is an automatically determined location designation designating a current location of the computing device.

In Example 58, Example 56 may optionally include prompting the user to input the pick-up location designation and the destination designation; and receiving input from the user designating the pick-up location designation and the destination location designation.

In Example 59, any of Examples 56-58 may optionally include determining one or more recommended taxi cabs registered with the distributive taxi dispatching service based on the received taxi information, wherein the displaying the requested taxi information includes displaying a list of the one or more recommended taxi cabs.

Example 60 may include the subject matter of any of Examples 57-58, wherein the received taxi information includes information regarding one or more recommended taxi cabs registered with the distributive taxi dispatching service.

Example 61 may include the subject matter of Example 60, wherein the information regarding the one or more recommended taxi cabs includes, for each of the one or more recommended taxi cabs, a cab identifier and one or more of an estimated time of arrival, a recommended route, an estimated fare, and a rating.

In Example 62, Example 60 or Example 61 may optionally include allowing the user to select a taxi cab of the one or more recommended taxi cabs; and sending the user's selection of the taxi cab to the distributive taxi dispatching server.

In Example 63, Example 62 may optionally include displaying an inquiry, when the computing device moves away from the location designated by the pick-up location designation asking if the user still has need for a taxi; prompting the user for a response to the inquiry; and sending the response to the inquiry to the distributive taxi dispatching server.

Example 64 may include the subject matter of any of Examples 56-63, wherein the request for taxi information further includes a passenger profile of the user.

Example 65 may include the subject matter of Example 64, wherein the received taxi information includes information regarding one or more recommended taxi cabs registered with the distributive taxi dispatching service that takes into account the passenger profile of the user.

In Example 66, Example 64 or Example 65 may optionally include allowing the user to edit the passenger profile via the user interface.

Example 67 may include the subject matter of any of Examples 51-63, wherein the received taxi information includes information regarding one or more taxi cabs registered with the distributive taxi dispatching service that takes into account a passenger profile of the user.

In Example 68, Example 51 may optionally include displaying an inquiry asking if the user would like to take a taxi due to current conditions at a current location of the computing device.

In Example 69, any of Examples 51-68 may optionally include obtaining confirmation that the user is inside a taxi cab registered with the distributive taxi dispatching service based on the provided taxi information.

In Example 70, Example may optionally include obtaining information regarding the user's ride in the taxi cab.

In Example 71, Example 70 may optionally include allowing the user to enter feedback regarding the user's ride via the user interface.

In Example 72, Example 70 or Example 71 may optionally include updating a passenger profile of the user based on the obtained information regarding the user's ride.

In Example 73, any of Examples 69-72 may optionally include receiving an alert from the distributive taxi dispatching server indicating that the user may not he safe; and displaying the alert via the user interface.

In Example 74, Example 73 may optionally include prompting the user as to whether the user needs emergency help; and if the user indicates that help is needed, sending a request for emergency help.

In Example 75, any of Examples 69-72 may optionally include monitoring a current location of the computing device; and displaying an alert if there is an indication that the user may not be sale.

In Example 76, Example 75 may optionally include determining, based on a response to the alert, or lack of a response to the alert within a given timeframe, that the user is not safe; and sending a request for emergency help.

Example 77 may include the subject matter of Example 75 or Example 76, wherein the indication that the user may not he safe includes indication of one or more of speeding beyond a given speed threshold, erratic driving, deviation from an expected route beyond a given deviation threshold, or location in a designated unsafe zone.

In Example 78, any of Examples 69-77 may optionally include allowing the user to pay for the taxi cab via the user interface.

Example 79 may include at least one machine readable medium comprising a plurality of instructions that in response to being executed on a computing device, cause the computing device to carry out a method according to any one of Examples 51-78.

Example 80 may include an apparatus configured to perform the method of any one of the Examples 51-78.

Example 81 may include a computer system to perform the method of any of Examples 51-78.

Example 82 may include a machine to perform the method of any of Examples 51-78.

Example 83 may include an apparatus comprising means for performing the method of any one of Examples 51-78.

Example 84 may include a computing device comprising memory and a chipset configured to perform the method of any one of Examples 51-78.

1-25. (canceled)

26. A distributive taxi dispatching server associated with a distributive taxi dispatching service, comprising:
one or more data stores having stored therein one or more of registration data relating to users and taxi cabs registered with the distributive taxi dispatching service, historical data relating to the registered taxi cabs, or passenger profiles of the registered users;
a processor;
a communication system in communication with the processor and a network; and
a memory in communication with the processor, the memory having stored therein a plurality of processing instructions adapted to direct the processor to:
receive, from a user device of a registered user, a request for taxi information;
obtain the requested taxi information from one or more computing devices of one or more taxi cabs or taxi service companies and from the one or more data stores; and
provide the requested taxi information to the user device.

27. The distributive taxi dispatching server of claim 26, wherein:
receiving the request for taxi information includes receiving a photo of an identifier on a taxi cab;
obtaining the requested taxi information includes verifying that the taxi cab identified by the identifier is registered with the distributive taxi dispatching service; and
providing the requested taxi information to the user device includes providing, to the user device, the results of the verification that the taxi cab is registered with the distributive taxi dispatching service.

28. The distributive taxi dispatching server of claim 27, wherein:
obtaining the requested taxi information further includes obtaining one or more of pricing or rating information for the taxi cab; and
providing the requested taxi information further includes providing one or more of the pricing or the rating information for the taxi cab.

29. The distributive taxi dispatching server of claim 26, wherein:
receiving the request for taxi information includes
receiving a pick-up location designation from the user device;
receiving a destination designation from the user device, and
obtaining a passenger profile of the user;
obtaining the requested taxi information includes obtaining availability information, pricing information, and location information regarding registered taxi cabs; and
providing the requested taxi information to the user device includes
determining one or more recommended taxi cabs based on user preferences and the obtained availability information, pricing information, and location information of registered taxi cabs, and
providing information regarding the one or more recommended taxi cabs to the user device.

30. The distributive taxi dispatching server of claim 29, wherein the determining the one or more recommended taxi cabs is further based on historical data of registered taxi cabs.

31. The distributive taxi dispatching server of claim 29, wherein the determining the one or more recommended taxi cabs is further based on current conditions at a first location represented by the location designation and a second location represented by the destination designation.

32. The distributive taxi dispatching server of claim 29, wherein the providing information regarding the one or more recommended taxi cabs to the user device includes providing to the user device, for each of the one or more recommended taxi cabs, a cab identifier and one or more of an estimated time of arrival, a recommended route, an estimated fare, and a rating.

33. The distributive taxi dispatching server of claim 29, wherein the plurality of processing instructions is further adapted to direct the processor to:
receive a requested pick-up time from the user device;
receive a taxi cab selection from the user device; and
schedule the requested pick-up time with a taxi cab associated with the taxi cab selection.

34. The distributive taxi dispatching server of claim 33, wherein the plurality of processing instructions is further adapted to direct the processor to:
monitor a current location of the user;
determine, based on the requested pick-up time and current location of the user, an estimated time of arrival of the user at the pick-up location; and
if the difference between the estimated time of arrival and the requested pick-up time is greater than a given lateness threshold, re-schedule a new pick-up time with the taxi cab.

35. The distributive taxi dispatching server of claim 29, wherein the pick-up location designation is an automatically determined current location of the user device.

36. The distributive taxi dispatching server of claim 29, wherein the plurality of processing instructions is further adapted to direct the processor to:
receive a request to schedule a ride with a chosen one of the one or more recommended taxi cabs;
schedule the ride with the chosen taxi cab;
monitor a current location of the user device;
determine, based on the current location, that the user has moved away from a location represented by the pick-up location designation;
send an inquiry to the user device asking if the user still has need for a taxi;
receive a response to the inquiry;
if the response to the inquiry confirms that the user still has a need for a taxi, update the scheduling for the taxi with a new pick-up location designation; and
if the response to the inquiry confirms that the user no longer needs a taxi, cancel the scheduling of the chosen taxi cab.

37. The distributive taxi dispatching server of claim 26, wherein the plurality of processing instructions is further adapted to direct the processor to:
determine a current location of the user device;
determine current conditions at the current location; and
send an inquiry to the user device asking if the user would like to take a taxi.

38. The distributive taxi dispatching server of claim 26, wherein the plurality of processing instructions is further adapted to direct the processor to:
receive confirmation that the user is inside a registered taxi cab.

39. The distributive taxi dispatching server of claim 38, wherein the plurality of processing instructions is further adapted to direct the processor to:
obtain information regarding the user's ride in the taxi cab.

40. The distributive taxi dispatching server of claim 39, wherein the obtaining of information regarding the user's ride includes obtaining route and duration of travel information by monitoring the current location of the user device from a pick-up location to a destination location.

41. The distributive taxi dispatching server of claim 39, wherein the obtaining of information regarding the user's ride includes receiving user-entered feedback regarding the ride from the user device.

42. The distributive taxi dispatching server of claim 39, wherein historical data regarding the taxi cab is updated based on the obtained information regarding the user's ride in the taxi cab.

43. The distributive taxi dispatching server of claim 39, wherein a passenger profile of the user is updated based on the obtained information regarding the user's ride in the taxi cab.

44. The distributive taxi dispatching server of claim 38, wherein the plurality of processing instructions is further adapted to direct the processor to:
monitor a current location of the user device; and
provide an alert to the user device if there is an indication that the user may not be safe.

45. The distributive taxi dispatching server of claim 44, wherein the plurality of processing instructions is further adapted to direct the processor to:
determine, based on a response to the alert from the user device or lack of a response to the alert from the user device within a given timeframe, that the user is not safe; and
alert authorities with a location and identification of the taxi cab, user, or both.

46. The distributive taxi dispatching server of claim 45, wherein the indication that the user may not be safe includes indication of one or more of speeding beyond a given speed threshold, erratic driving, deviation from an expected route beyond a given deviation threshold, or location in a designated unsafe zone.

47. The distributive taxi dispatching server of claim 38, wherein the plurality of processing instructions is further adapted to direct the processor to:
receive payment information from the user device; and
provide the payment information to the appropriate taxi cab or taxi service company.

48. A non-transitory computer-readable medium storing control logic configured to instruct a processor of a computing device to:
receive, from a user device of a user registered with the distributive taxi dispatching service, a request for taxi information;
obtain the requested taxi information from one or more computing devices of one or more taxi cabs or taxi service companies and from one or more data stores, the data stores having stored therein one or more of registration data relating to users and taxi cabs registered with the distributive taxi dispatching service, historical data relating to the registered taxi cabs, or passenger profiles of the registered users; and
provide the requested taxi information to the user device.

49. An apparatus associated with a distributive taxi dispatching service, comprising:
means for receiving, from a user device of a user registered with the distributive taxi dispatching service, a request for taxi information;
means for obtaining the requested taxi information from one or more computing devices of one or more taxi cabs or taxi service companies and from one or more data stores, the data stores having stored therein one or more of registration data relating to users and taxi cabs registered with the distributive taxi dispatching service, historical data relating to the registered taxi cabs, or passenger profiles of the registered users; and
means for providing the requested taxi information to the user device.

50. A method of providing a distributive taxi dispatching service, comprising:
receiving, from a user device of a user registered with the distributive taxi dispatching service, a request for taxi information;
obtaining the requested taxi information from one or more computing devices of one or more taxi cabs or taxi service companies and from one or more data stores, the data stores having stored therein one or more of registration data relating to users and taxi cabs registered with the distributive taxi dispatching service, historical data relating to the registered taxi cabs, or passenger profiles of the registered users; and
providing the requested taxi information to the user device.
